(19) United States
(12) Patent Application Publication
(10) Pub. No.: US 2007/0157155 A1
(43) Pub. Date: Jul. 5, 2007

(54) System and method for software generation and execution

(76) Inventor: Eric Charles Peters, Carlisle, MA (US)

Correspondence Address: WOLF GREENFIELD & SACKS, P.C., 600 ATLANTIC AVENUE, BOSTON, MA, 02210-2206, US

(21) Appl. No.: 11/323,260

(22) Filed: Dec. 30, 2005

(51) Int. Cl. G06F 9/44

(52) U.S. Cl. 717/100

(57) ABSTRACT

A method and system used to create a large class of computer programs. Software systems result from programming the behavior of groups of objects, each representing data and/or services. The system includes objects (comprising data and one or more rules), rules defining potential behaviors of objects, requests for triggering object behaviors or actions, and a message-handling mechanism for communicating data and requests and controlling the order of executing requests. In memory, a workspace comprises a root object and at least one additional object, different from the root object, having at least one field for containing data and at least one rule. The rule defines a behavior which is to occur when specified data conditions are satisfied. A queue receives requests for action with respect to the additional object; an interpreter evaluates a request from the queue and fires a rule when its specified data conditions are satisfied.

### BACKGROUND

1. Field of Invention

This invention relates to the field of computer systems, in general, and, more particularly, to facilitating the development, operation, and maintenance of computer software (i.e., computer programs) for those systems.

2. Discussion of Related Art

Computer software is one of the modem world's ubiquitous tools. Many of today's business corporations, government agencies, educational and other non-profit organizations, and other various entities, as well as individuals and embedded controls in many systems (such as traffic lights or automobiles, to name two) use computer systems to gather, store and process data. Such systems have innumerable uses in connection with, among many other things, managing business transactions and processes, keeping track of an entity's financial information and resources, tracking the shipment of products and supplies, and processing and providing data reports. Software is used also for educational, entertainment, control and myriad other purposes. Today's personal and institutional reliance on computer systems is manifest. These computer systems run countless kinds of software that must be capable of handling and safeguarding a vast amount of data dealing with the various aspects of our modem world. A range of software is involved, from operating systems to utilities to application programs.

Developing, maintaining, and operating software typically involves a significant amount of work and investment. Many software systems in use today embody complex processing and require multiple large programs written or revised over time by multiple software developers to implement and maintain various parts of the system. Having such large programming systems implemented by a number of software developers leads to inefficiencies, contributes to cost and introduces problems such as one developer understanding another's source code. Considerable attention thus is usually paid to documentation and error handling. For example, if the system were to malfunction or crash, finding the source of the error or how the error impacted other parts of the system is usually important but difficult, at best. This often makes the process of error correction time-consuming and troublesome.

In most current software systems, the ability to track the history of data is also difficult. This is problematic as in some instances, it may be necessary to find the last person to see the data or modify it in order to recover the state of the system correctly, or to diagnose the cause of an error.

Consequently, in modern complex management information systems (MIS) or other computer systems, the development, error-correction, updating and modification of its software can be a major expense item and a factor limiting how fast changes can be implemented.

Complexity contributes to these cost and time factors. A change to a single aspect of a business process or other kind of program can ripple through many software modules. Sometimes the consequences are unintended and unwanted. So, the software development project may require additional overhead expenses in the form of tracing the interdependency of variables and processes. Actually writing the program code may be one of the smaller parts of the entire project.

Due to these complexities, a high level of programming or computer science expertise often is required to implement an organization's management needs in software. However, programmers and computer scientists generally lack expertise in the particular domain of the business agency, foundation or other entity for which the software is created and managed. Therefore, domain expertise and software expertise are separated. This results in obvious inefficiencies: the domain expert has to become a programmer, the programmer has to acquire domain expertise (both of which may take a long time to learn) or the two have to operate as a team, adding coordination and communication time to their individual efforts.

Difficulties also arise when changes or additions have to be made to an already implemented system. Yet software developers must constantly update software code in order to implement changes of many types: platform changes, changes to business processes and conditions, regulatory changes, etc.

Consequently, there has long been a desire for a more efficient, less problematic method of implementing and maintaining (e.g., adding to, deleting from, or changing) software systems used to receive, generate and process data, particularly (but not limited to) enterprise-level business operations.

Similarly there has been a desire for improved error handling in such systems so that errors can be more efficiently analyzed and resolved or even corrected before the error can occur and cause havoc to the rest of the system.

In connection with addressing these desires, it has also been recognized that in large systems with multiple users, assuring all users are exposed to the same data at the same time is required, but most approaches for doing so add considerable complexity and inefficiencies.

### SUMMARY

A programming environment that is similar to an object-oriented programming environment greatly reduces the time required for creating a large class of computer programs, while at the same time improving the programs' understandability, flexibility, and robustness, and adding capabilities such as the ability to use multi-processors and multicore processors automatically and the ability to create distributed applications with little or no extra effort. Larger software systems result from programming the emergent behavior of groups of individual objects, each object representing data and/or services. The principal atomic units of the system include objects (each of which comprises data and one or more rules), rules which define potential behaviors of objects, requests for triggering object behaviors or actions, and a message-handling mechanism for communicating data and requests and controlling the order of executing requests.

Incremental programming may be achieved without creating new programming environments or greatly affecting the preexisting source code. The programming environment provides data structures which are capable of taking the burden of software programming off of a software developer. The programming environment also provides improved means of data locking, data sampling, and security.

There are a great many aspects of this system and methodology that are considered new and which are intended as aspects or facets of the invention and which are highlighted by the discussion below of one or more illustrative examples. Not all of such aspects are repeated here.

According to a first aspect, a method is shown for use in a computing system, the method comprising: reating in a memory of a computer a workspace which comprises a root object; creating in the workspace, at least one additional object, different from the root object, wherein the at least one additional object comprises at least one field for containing data and at least one rule, wherein the at least one rule defines a behavior which is to occur when specified data conditions are satisfied; providing a queue which receives a request for actions with respect to the at least one additional object in the workspace; and providing an interpreter which evaluates the request received from the queue and fires the at least one rule when the specified data conditions are satisfied.

Providing a queue may comprise providing a short-cut request queue which receives minor requests from the at least one object addressed to itself and provides such requests to the interpreter. Providing a queue also may comprise providing an input request queue which receives major requests from at least one object, other than the at least one object receiving the request, or from a user and provides such requests to the interpreter. Receiving major requests may comprise receiving a request from an adapter and providing sad request to the input request queue. In turn, receiving a request from an adapter may comprise receiving a request from an external source or receiving a request from another workspace.

In any of the foregoing, firing the at least one rule may comprise providing modifications to the at least one additional object in temporary memory location and if said modifications are completed without the occurrence of an error, the modifications are permanently made to the at least one additional object.

All minor requests on a short-cut queue may be processed before a next major request on an input request queue, for the same at least one additional object, is processed.

According to a second aspect, another method is shown, for use in a computing system, the method comprising: creating in a memory of a computer a workspace which comprises a root object index; creating in the workspace, at least one additional object different from the root object index; and providing an addressing system wherein the root object index and the at least one additional object are associated in a tree structure through a key associated with the at least one additional object.

Another aspect is a method for use in a computing system, wherein the computing system comprises an object in a workspace, the object further comprising at least one field comprising data and at least one rule, and the method comprises acts of: isolating the object once said object has received a first request for actions, with respect to the object, from an input request queue; and processing the first request by evaluating at least one rule associated with the object and wherein the object may not receive a second request for actions until the first request has been completed.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagrammatic example of an embodiment of a computing system as taught herein;

FIG. 2 shows a schematic illustration of an example object and its various fields and the contents thereof according to an embodiment of example software system;

FIG. 3 displays diagrammatically an embodiment of an example workspace tree structure comprising objects interrelated in the manner taught herein;

FIG. 4 depicts diagrammatically an example of an embodiment of a workspace and user interface structure as taught herein;

FIG. 5 is a diagram depicting a pathstring example for object addressing;

FIG. 6 is a diagram of an example of a request structure;

FIG. 7 is a diagram of an example of request processing; and

FIG. 8 shows a flow chart of an example of request processing.

### DETAILED DESCRIPTION

This invention is not limited in its application to the details of construction and the arrangement of components set forth in the following description or illustrated in the drawings. This description and the drawings are provided to explain aspects of, and show examples of how one might practice the invention, not to define or limit the invention. The invention is capable of other embodiments and of being practiced or of being carried out in various ways, only some of which are represented herein. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Definitions

Many terms used herein will be seen to have particular meanings. Without excluding definitions that may appear in context, the following glossary is offered to collect together in one place definitions of many of the defined terms used below:

“Frame” as used herein refers to a process specific to an object, wherein an interpreter—which may be implemented as a machine or as computer software, or a combination of both—receives a request directed to the object, processes the request to a point it is accepted or rejected, and sends out any additional requests to other objects which may be thereby generated.

“Index” as used herein refers to an object some of whose data fields serve as a map of objects. An index is used to locate other objects in the computing system.

An “interconnection” as used herein is a pointer or series of pointers leading from an object to another object

“Object” as used herein means a data structure in memory comprising at least one field, which may include data and/or rules.

“Request” as used herein means a message sent to an object in order, for example, to send data to, request data from, trigger behavior, or make changes to the object.

“Rule” as used herein means a user-defined string of code, which is used to define a potential behavior of an object.

“Workspace” as used herein means a data structure in memory comprising a tree of pointers from a node to one or more other nodes, wherein the tree comprises a root object and may further comprise at least one additional object, as defined above.

Overview

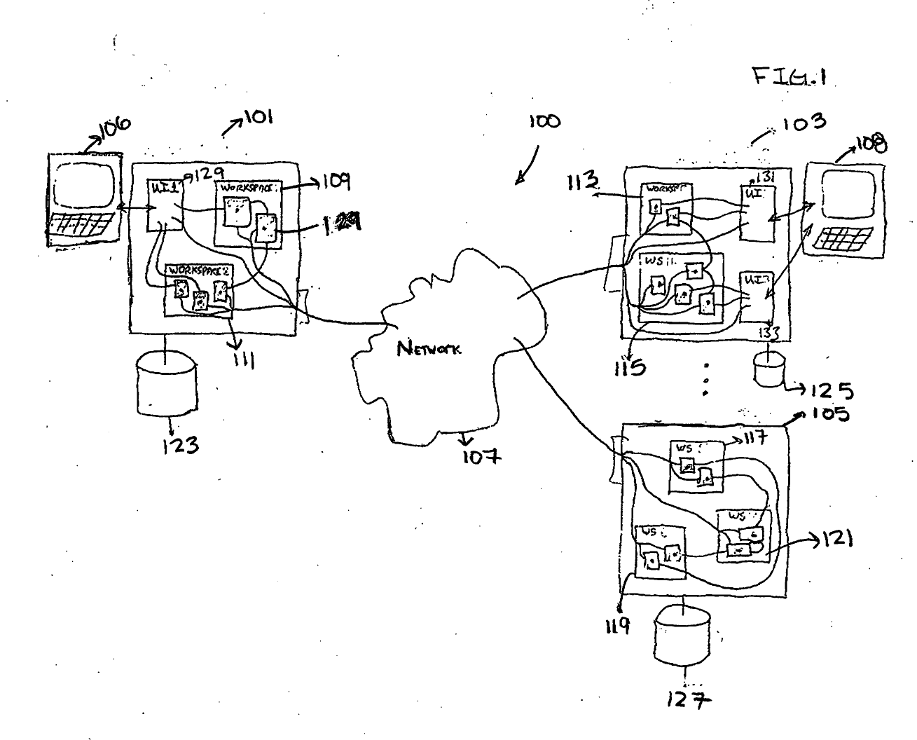

FIG. 1 depicts an example of a computing system, presented for teaching purposes and not intended to be limiting, illustrating in general terms an embodiment of a system according to the principles taught herein. Multiple computers 101, 103 and 105 are interconnected via a network 107. (It should be appreciated that most of the principles discussed herein apply, as well, to a single stand-alone computer, and multiple computers are shown without excluding the stand-alone environment. Three computers are shown, intending to represent a network of arbitrary size.) On each computer, software is provided that generates one or more data structures called “workspaces” (e.g., workspaces 109, 111, 113, 115, 117, 119 and 121). Workspaces may be implemented in any of several ways: for example, by using a high level programming language, preferably an object oriented programming language such as Java or C++, or by using other programming methods such as assembly language. Workspaces may even be implemented as a special purpose set of hardware, so long as it embodies the components and capabilities described below. The particulars of the tool(s) used to build and modify workspaces will depend on the circumstances of implementation and the invention is not intended to be limited in this respect. Each computer may hold from one to many workspaces. Computer 101, for example, is illustrated with workspaces 109 and 111; computer 103, with workspaces 113 and 115; and computer 105, with workspaces 117, 119 and 121. Each computer station also may include one or more file systems or database(s) (e.g., 123, 125, and 127), which may be used to store a workspace or may be used to create a copy of an entire workspace or group of objects.

Workspaces are populated, in turn, with objects. An object is another data structure in memory. It is composed of one or more named fields, which may include fields containing data and/or rules.

All changes and data requests (for reading and writing data) to objects are made with the use of “requests.” An object (i.e., in some implementations an interpreter processing rules in a target object) may choose to deny (i.e., refuse to process) or accept (i.e., process) a request as determined by evaluation of the rules stored in the object, which govern the behavior of the object.

The interaction of objects and requests is managed at least partly using a mechanism called a “frame.” A frame is a process which starts once an object receives a request. Requests may come from another object, a user interface (UI) or an external service (via an interface called an “adapter”), or from other unrelated software which implements the request protocol. The frame essentially takes control of the destination object and assures processing of requests in a controlled, orderly fashion. A frame processes the request in the context of the target object. The frame will end once (1) the object encounters an error, (2) the request has been denied execution, for example by the object executing a command called “abort”, or (3) the request (and all subsidiary request) processing is complete and any resulting requests are sent by the object, if the latter are required.

Several features of frames enhance their processing and enhance the overall programmability of the system:

One, frames are all-or-nothing, with a notable exception described below. It means a frame either completes in its entirety with no errors, or it is rolled back such that all its effects are removed, as if it never happened, except for a possible report. The exception to this all-or-nothing principle is the “remove rule” request, which has the purpose of removing rules from within the object. “Remove rule” requests are executed immediately and cannot be rolled back. This behavior is important to allow bad rules which might trigger errors or aborts to be removed; otherwise, such a rule could never be removed, since it would always be restored by the rollback operation.

Two, only one frame at a time may execute on a given object. All other frames directed to the same object must wait (e.g., in a queue) for the current frame to finish. Thus, the frame is atomic on the target object, and it cannot be interrupted by another frame on the same object. A corollary to this requirement is that frames on separate objects may run in parallel with each other.

Three, each frame is local to the object running the frame (i.e. the target object), which means rules executing within the frame can access only information from within this object, or information from user functions. (“User functions” are subroutines, generally implemented in a computer language such as Java or C++, which provide information, useful algorithms or other support to the rules executing within an object.) Four, the request which began the frame may propose changes to the target object, which changes may be accepted and made persistent at the end of the frame, but rules executing within the frame cannot directly change the state of this object. The only state changes that are allowed from rules within a frame are the following: i) editing the contents of the incoming request (e.g. with the “iset” command); ii) setting the value of temporary variables; and iii) composing and sending new requests. If the frame aborts for any reason, all these state changes plus any initial effects of receiving the request are rolled back as if the frame never happened, but a report consisting, for example, of text in a log file or an object or objects created in the workspace may report the abort.

Five, a request is not allowed to wait for anything. All the information needed to process a frame must be present in local memory and immediately accessible, or the frame must fail. Processing non local information, for example from a remote object, a file or a database, the system must take multiple frames to first request the desired information, and then to process that information when it finally arrives.

The processing of a request, during a frame, may involve the processing of resulting requests to the same object. That is, when processing a request “R” to an object “O,” the object “O” (i.e., implemented as the interpreter processing the request for the object) may generate one or more additional requests for object “O”. Those additional requests have a high priority and are processed immediately after the frame concludes and before other requests are allowed to communicate or interact with object O. Thus, request “R” “owns” object “O” until all processing of object O (relative to request R) is exhausted.

Preferably, the user can create, view and modify workspaces and objects via a user interface (UI) module, preferably a graphical user interface (GUI). A computer station may contain any number of UIs. As seen in FIG. 1, computer station 101 comprises one UI 129 and computer station 103 comprises two UIs 131 and 133. A UI is not a necessary component of a computer station, as seen in computer 105 which does not contain a UI. A UI may interact with any number of workspaces. A user is capable of interacting with a UI through Basic Input/Output System (BIOS) devices such as video display terminals (106 and 108) including keyboard, mouse and screen or other input/output devices.

Objects

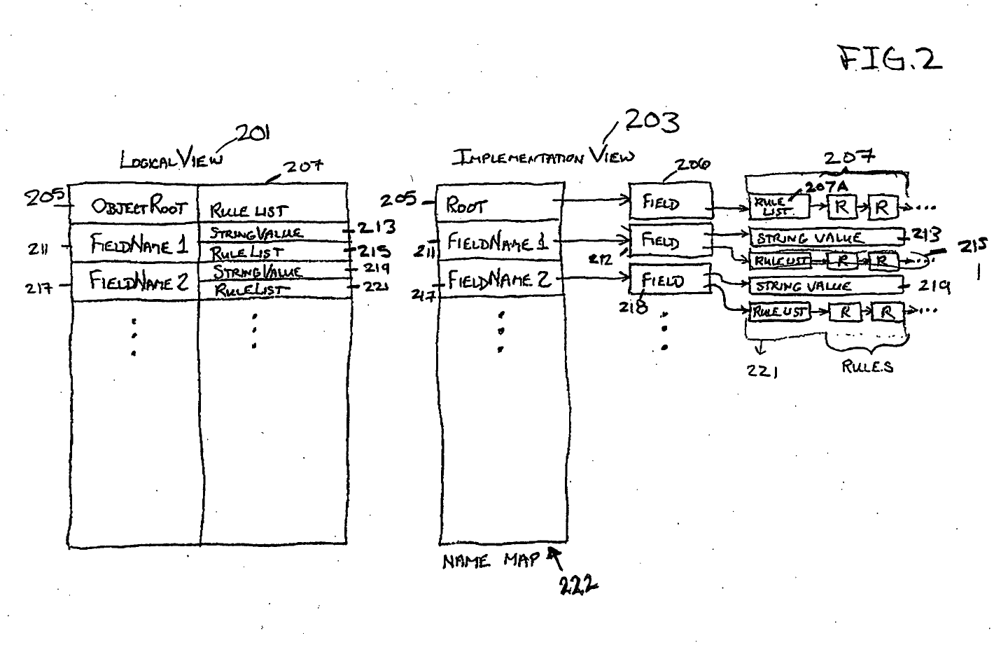

Objects are the addressable units of information in the computing system. An object may be analogized to a sheet of paper, a business record, a form, a list, an index, a container, or any other information collection one wishes to store as a unit. The rectangles with dots in the middle in FIG. 1, such as rectangle 129 in workspace 109, represent objects. FIG. 2 depicts the logical structure of an object 201, and the implementation view of an object 203. The logical structure of an object 201, represents a functional view of the object as a set of named fields, as well as how an object may be viewed in a form view. The implementation view of an object 203, represents a schematic of the object as implemented in software, for example in Java or C++ programming language. It may be implemented as a field name map which, when given a field name, returns a reference to the desired field information. The field name map may be implemented for example as a “Map” object in Java (see Java class definitions); preferably a “SortedMap” so that the fields will be presented in a consistent order should a user wish to view them or iterate through them. The field names in an object may be any strings of characters which the underlying Map class will accept as keys. Given this freedom, it is helpful to establish conventions on the naming of fields to facilitate programming in the system. The system itself may place, for example, control and debugging information (often called “metadata”) into object fields thought of as “system fields”. By convention all system fields may have names beginning with a common prefix such as “s.”. At the same time, users may have any field names they desire so long as they begin with the prefix “u.”; thus keeping the system and user name spaces separate, and imposing the fewest restrictions on user field names. Furthermore, if this convention is followed, it may be convenient if the interpreter assumes that any reference to an unprefixed field name (e.g. one that does not begin with “s.” or “u.” in the convention above) should have the “u.” user prefix supplied automatically. Thus, a simple reference such as “x” would be assumed to be a user field, “u.x”, which is likely to be the most usual case. Of course, other field naming conventions may be employed in addition to or instead of these, depending on the needs of the implementers, programmers, and users of the system.

One such naming convention might be the naming of user index fields, for use by path strings (detailed later). Objects which may be used to help follow path strings often need an “index map” of key strings to object references. It can use this map when a path follower needs to look up a key. One way to implement such a map is to put it into a subset of user fields; where, for example, each index field name has a distinctive form such as a prefix “u.i.” (standing for “user index”) followed by the key to be defined by the named field. Thus, for example, three index fields, for the keys “x”, “y” and “zed” would be “u.i.x”, “u.i.y” and “u.i.zed”, and the corresponding fields' values would be references (e.g. GUIDs, see below) of the objects to be referenced.

GUID

All objects are created and contained in workspaces, and upon creation, each object is given an identifier called a GUID, for “Globally Unique IDentifier”, which distinguishes it uniquely from all other objects. Since in this system, every object must be locatable using only its GUID, the GUID must contain a clear indication of the workspace where the object can be found, and an object may never move from the workspace where it was created. A map in each workspace called the oblist, for “object list” (discussed below) is used to keep a record of all the GUIDs and associated objects located in the workspace.

Creation of GUIDs may be “strict,” in that efforts are made to insure that each GUID is unique for all possible systems over all time. The art of creating such GUIDs is well known, using combinations of hardware addresses (for example the “MAC” address of a network interface), time stamps, and random seeds (see, for example, the “uuidgen” command in the Linux operating system). Alternatively, the creation of GUIDs may be “relaxed”, where the GUID is unique only in a limited context; for example, by taking the name of the containing workspace, and combining it with an autoincrementing integer. The form of the GUID, strict, relaxed, or some intermediate combination of the two, is not critical to this invention except that each GUID must be unique in any context in which it is used, and it must contain an unambiguous indication of the workspace in which it was created.

Object Fields

To a user, an object may be displayed as a table containing an object root 205 and fields 211-215, 217-221, as seen in the logical view 201. Object root 205 is a special field which may contain only a rule list 207. Rules in this rule list of the object root can see and be fired by any request which comes to the containing object or any of its fields. In a sense, the object root field acts like a hierarchical “container” for the other fields in the object. Rules on other fields in an object can see and be fired only by requests which come to the containing object and which are directed to that specific field. It may be desirable to arrange the fields of an object in a multilevel hierarchy, where the object root field is at the top of the hierarchy, and there are subsidiary fields beneath it which may contain groups of fields, which may also contain groups of fields, and so on for as many levels as desired. In such a case, rules on a field which contains other fields may respond to the requests which come to any of those fields. Such a hierarchy gives the ability to control an object's fields in groups, and apply general rules to such whole groups of fields. On the other hand, it may be decided to limit the hierarchy of fields to a minimal number of levels (e.g. the object root field and all other fields as a single group), to improve performance of the interpreter.

All information is contained in strings within data fields 211 and 217. Each of the data fields 211 and 217 has a name associated with it, which may be used to address the particular field using the field name map described earlier. Each data field 211 and 217 comprises a string value 213 and 219, respectively, and a rule list 215 and 221, respectively. A user may create or change the contents of data fields 211 and 217 by sending suitable requests to the containing object. For instance, upon receiving a “set request” (see below) for a field, a frame is started during which the interpreter may cause the field to take on the data value from the request. Requests can ask that fields be modified in many ways, for example by changing the field's data contents, adding or deleting rules from the rule list, or even deleting the field entirely. As noted earlier, rules on the field or on the object may accept or reject such changes.

As seen in the illustrative implementation view 203, an example of an object is an instance of a series of various class objects in Java interconnected through references. The top level of the object is implemented as a map of the object's field names, called the “field map” or the “field name map”, interconnected to the individual fields of the object, as described above, plus any desired meta information used to implement and manage the object, such as a flag used by the garbage collector to mark the object for disposal. Object root 205 may be implemented as an instance of a Field class object 206 in Java, which is in turn connected to a rule list 207 through a series of references. A field name such as “” (i.e. the empty string), or some other distinguished field name, may be used to refer to the Object root field 205 in the field map. Rule list 207 consists of an instance of a RuleList class object in Java, 207A, connected to individual rules, R, through a series of references (denoted by the arcs from one to the next). Data fields may be implemented using the object's fieldname map , in which two example fieldnames 211 and 217 are depicted. The object's fieldname map 222 is interconnected to instances of Field class objects (in Java), such as instances 212 and 218, respectively. Field class objects 212 and 218 are, in turn, interconnected to instances of String classes 213 and 219, respectively. Each of these String class instances 213 and 219 stores the data value associated with its corresponding field. Each of Field class instances 212 and 218 may also be interconnected to an instance of a RuleList class object 215 and 221, respectively. (For shorthand, we will refer at times to a field or a class where it should be understood that we mean an instance of a Field class object (in Java) or an instance of some other class object, in the described example implementation.)

Rules

Each of rules lists 215 and 221 comprises a list of user-defined rules. The rule list may be implemented using a “Collection” kind of object such as the “List” or “Set” class object in Java, or a similar class. The advantage of using a “Set” class, which permits only unique entries—no duplicates—for the list of rules is that it requires all rules on each object field to be unique, which is a useful discipline for preventing bugs. The rule list may be implemented as a map, if in an implementation it is found desirable to give each rule in the list a unique name. Alternatively, the “name” of a rule may simply be its contents.

Rules are strings of code which respond to changes and other actions directed toward corresponding fields, are invoked by requests, and give an object its behavior. Request messages propose changes to objects, invoke behaviors, and may ask for data contained in an object. An object (i.e., Rules run by an interpreter which processes requests for an object) may choose to accept or deny requested actions such as changes or data requests, if such actions are not in compliance with the corresponding rules, which will be discussed later.

One example of a useful rule, which may be contained in an object field, is a “listener” rule. A listener rule is one which will report, perhaps to a UI, any changes made to the object. Listener rules may be placed on objects of interest and cause an object to resend any request message it receives which may have caused the state of the object to change. With the use of listener rules, the UI is able to keep track of, and display, the current state of any object(s). Listener rules may also be useful in error detection. For example, an object may contain a field into which is written a message each time an error occurs in the particular object. A listener rule may be placed on (i.e., set to observe) an error field, so as to notify the UI or any other object or part of the system when an error has occurred in the object. Desirably, when a listener rule is first applied to an object or field, it will fire immediately and send the entire current contents of the object or field in the same frame in which the listener was applied. This procedure prevents another request from intervening and changing the state of the object between the time when the state of the object is known and when the listener begins listening. Also, it is important that when a listener rule is triggered by a change, it reports the net effect of the entire change, including any editing of the incoming request which may occur within the resulting frame.

Workspaces; Object Trees

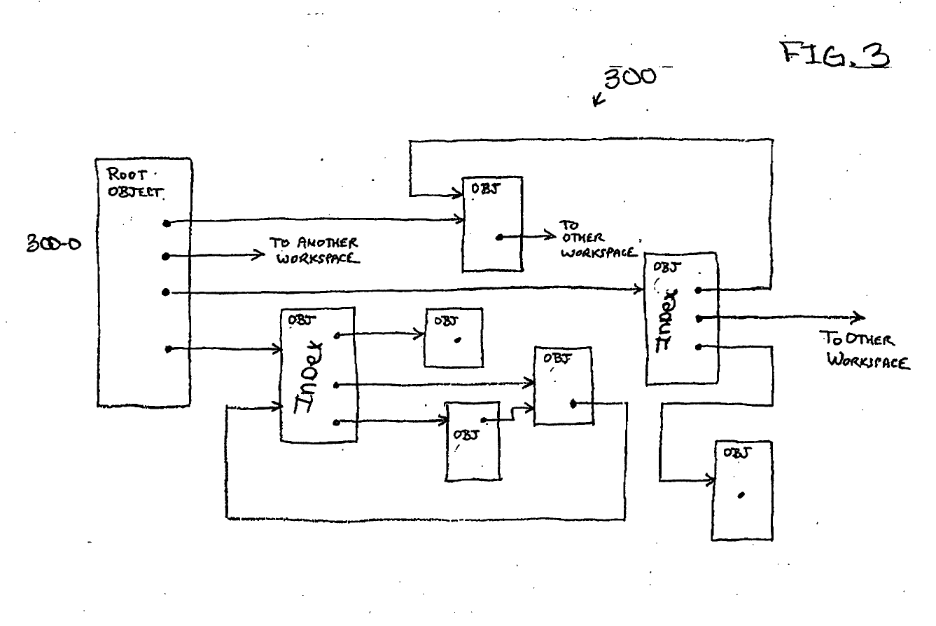

With reference to FIG. 3, objects in each workspace are kept in a tree structure 300. For example objects 300-0 through 300-7 are arranged in a tree structure with a root object 300-0 being the start of the tree. From the root object, an object tree is grown. Though referred to as a tree, it is not necessarily a proper tree in the usual data structure sense, in that additional references may be allowed across the tree or series of references that form loops. The only requirement is that all objects in the workspace, and thus in the tree are reachable by following references within the workspace directly or indirectly from the root. The tree is created by adding indexes referring to other indexes; therefore each object in a tree, except the root object, will (must) be indexed. The tree structure may include any number of indexes (in this example, each of objects 300-1 and 300-6 contains an index), which serve as a map used to refer to objects in the workspace.

Each tree structure is maintained in a workspace, and there may be only one tree in each workspace. Therefore, once a workspace is created, a root object 300-0 will automatically be created, as well. Workspaces may be created by a Java class (e.g. called “Workspace”) in an example implementation, which has methods to instantiate the Java objects underlying the workspace including the oblist and the root object, as well as the Java objects which implement the interpreter associated the workspace. The starting point for creating a new program using this system is the presentation to the programmer/user of a new workspace having only a root object therein. Preferably, but optionally, a mechanism may be provided to, on invocation, automatically initialize a new workspace with a copy of a template workspace from a known location, for example from the computer file system or an attached network. The user may then customize the template, and thus all new workspaces to include any features the user may need or want, generally by adding objects, fields, field values, and rules to the template workspace.

All objects are created and contained in workspaces, and upon creation, as stated above, each object is given an identifier called a GUID, for “Globally Unique IDentifier”, which distinguishes it from all other objects. When an object is created, its GUID is placed in an object list (“oblist”) map 405, along with a reference to its underlying data structure so an interpreter can access it. Since each created object is thus inextricably associated with its initial workspace, it may never move from the workspace in which it was created. The object list map 405 is used to keep a record of all the objects located in the workspace, along with the associated GUID of each object.

The root object 300-0 is the main index object for the workspace, and it must always be addressable at a known address (i.e. a known GUID), such as the name of the workspace followed by the characters “:0”, or another convention. For efficiency the root object preferably is addressable by a path (see below) in the workspace using a compact path string, such as “/”. All objects in a tree must be “interconnected” to the root object 300-0. An interconnection is a reference or series of references leading from an object to another object. Therefore, beginning with the root object 300-0, there exists a series of indexes in the workspace referring to other indexes and objects, thus forming the tree structure. All objects forming the workspace tree must be within the workspace in question, even though objects are allowed to refer to objects outside the workspace as desired. Thus, each workspace tree is composed of object references, but not all object references are part of the tree.

Index objects (known as “indexes” for short) such as the root object 300-0 and objects 300-1 and 300-6 enable a method of object location using “keys” and “pathstrings”. Indexes are ordinary objects, but they include one or more fields, known as index fields, intended to assist in the location of other objects. The index fields form a map of objects by connecting keys, which are text strings used to form part of the index fields' names, with particular objects, represented by the value of the index field containing the GUID of that object. Given a key (usually as an element of a pathstring), an index object can map that key to the object which is desired to be associated with that key by this particular index. Thus, indexes create a powerful and easy-to-use method of locating other objects in the computing system by expressing the relationships among the multiple objects. These relationships are expressed in “paths” which can lead a request from object to object, anywhere in the computing system, even from workspace to workspace, until the request reaches its desired target object.

Index field names, being a subset of user field names, may be formed by preceding each key string with a common prefix, such as the characters “u.i.” (which stands for “user index”), resulting in fields named as, for example, “u.i.John Doe” and “u.i.Jane Smith” (note spaces and other whitespace may be allowed in field names). The value of each index field is the GUID of an associated object in the system; in this example case, the value of each index field might be the GUID of the corresponding student record object for “John Doe” and “Jane Smith”.

When an object is created in a workspace, i.e. in a preexisting tree structure, it is indexed in order to be implemented in the workspace as part of the tree. The index where a new object is created is called the parent index of the new object. The key under which the new object is created in the parent is called the parent key and serves as a nickname (i.e., a convenient but not unique name) for the object, as will be discussed later. When a new object is to be created in a parent index, the parent index may optionally have a reference to another object to be used as a “template,” where the template supplies the initial contents of each new object created in this particular parent index. Thus, all objects created in a parent index may resemble each other, since they may be initially created from the same template. Templates are a good way to initialize new objects with particular fields, values, and rules.

Templates are ordinary objects in the system, and like all objects they may be constructed containing user defined fields and rules. Then, a reference to the template is placed into an object intended to serve as a parent where new objects will be created. This reference, in the example implementation, is in the form of a well known field name within the parent object, such as a field named “s.template”, and the user sets the value of this field to the GUID of the desired template object. Whenever the interpreter subsequently creates a new object in this parent (e.g., as a result of executing a create request), it checks to see if the “s.template” field exists there. If it does, it looks up the supplied GUID of the template (i.e. from the value of the “s.template” field) in the oblist and makes a copy of the referenced template object to use as the initial contents of the new object being created. When an object is created as described using a template, it is convenient to store the GUID of the template that was used in a field in the object being created; for example, a system field called “s.OrigTemplate”.

As a convention, it is suggested, but not required, that templates be themselves created in a particular parent object (called, e.g., “Templates”) and indexed directly by the root object of the workspace. This convention has several advantages such as making all the templates in a workspace available in one place, and thus easy to find. It also allows the user to create a “template template”; that is, a template object that defines the initial contents of all new template objects, and that are thus presumably passed along to all new objects created in the workspace using any template. Extending this technique, one could have a “super template” that supplies initial contents for any user selected subset of all templates by creating an object within the aforementioned “Templates” object which serves as the parent object for the members of the subset, and which has the GUID of the super template as the value of its “s.template” field. Note that since the interpreter looks up the GUID of the template from the s.template field using the oblist of the current workspace, it is required that the object to be used as the template exist in the current workspace. It might be easy to allow the interpreter to fetch the object from another (“foreign”) workspace by using ordinary requests, but it would make the process of creating a new object using a template asynchronous, which breaks the frame requirement that frames never wait for anything; in this case, the frame of the create request. Allowing templates from foreign workspaces would also mean that the template is not accessible if the particular foreign workspace is not available for any reason. Thus it would make it impossible to create new objects using that template whenever the foreign workspace is not on line.

The tree structure within a workspace need not be a proper tree and may contain loops 308 and cross references, thus enabling multiple paths in which an object may be addressed. The tree structure may also be interconnected to objects in other tree structures and workspaces within the same computer station 305, or on other computer stations, even if the other stations are not currently connected to the originating station 305. For example, in computer 101, workspace 109 contains object 2 which is connected to object 5 in workspace 111.

Additional workspaces may be implemented in the computing system at any point during the life of the software program. Such additions may be made without altering workspaces previously implemented in the system, thus making incremental programming easily possible. Therefore, if a user wished to expand on a preexisting system, there would not be a need to create an entirely new programming environment. Additions or alterations to a computing system may be easily done by adding or deleting an object, field, rule or workspace. All of the changes mentioned may be performed with the use of requests (see below). Such a system, as described above, allows for ease in making frequent changes or updates without greatly affecting the system already in place.

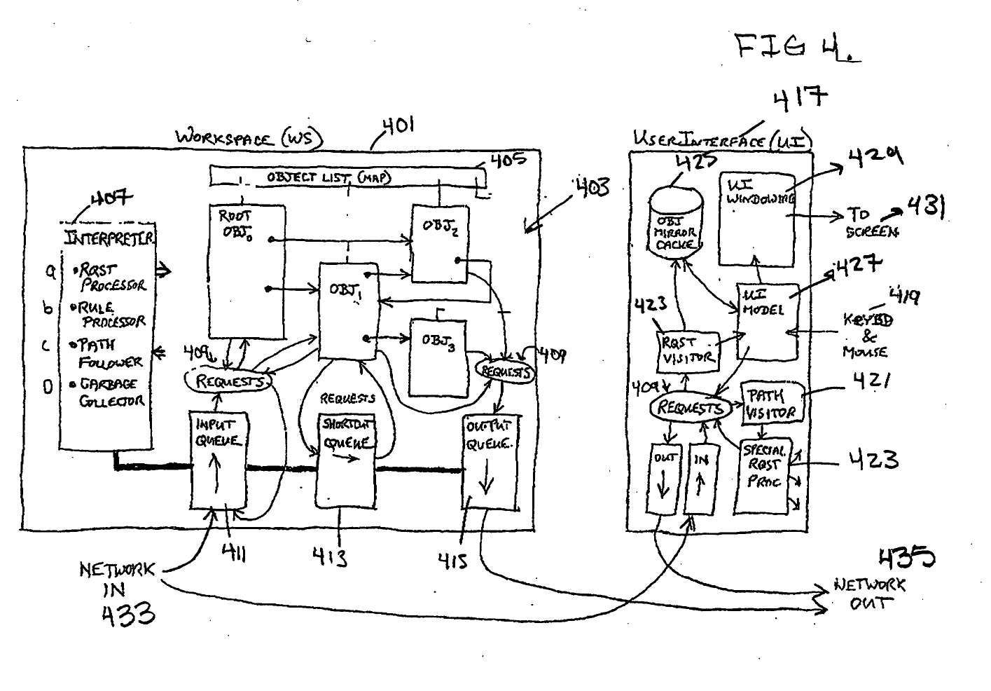

Periodically, a garbage collector utility 407-d (see FIG. 4) may be run in each active workspace to identify and delete objects that have been “orphaned” and are no longer part of the tree. The garbage collector frees up memory. For example, a workspace request “save” may allow a user to programmatically save the workspace to its backing file after causing the garbage collector to run. It is also desirable to provide a user controlled means of causing the garbage collector to run on demand. Some implementations may therefore include a user function, which when referenced, causes the garbage collector to run.

The art of garbage collection algorithms is well known (see, for example, “Garbage Collection—Algorithms for Automatic Dynamic Memory Management”, by Richard Jones, published 1996 and 1999 by John Wiley and Sons, Ltd., ISBN 0-471-94148-4). One implementation of this invention uses a simple mark and sweep algorithm, marking only objects that appear in the workspace tree and then eliminating all other objects from the workspace's oblist. More or less sophisticated algorithms may be employed. It is also assumed that the language and runtime environment used to implement this invention, for example Java, may include its own garbage collector which identifies objects at the implementation level which are no longer needed, and removes them from memory.

Intro. To Requests, Interpreter, Request Queues

FIG. 4 is a diagram displaying—at a schematic level—some of the main ways objects interrelate and interact within a workspace 401 and with a UI 417. Generally, objects communicate with one another only through “requests,” indicated by single-ended arrows or arcs 409. An object may send information, even a copy of itself, to other objects. All persistent state changes in an object or a workspace are made via requests. A request is a message, sent to an object, specifying an action. When a request is received at an object, the rules in the object are evaluated to determine whether their predicate conditions, e.g. their “on conditions” and “guard” if-conditions, are satisfied. When its conditions are satisfied a rule “fires.” —i.e., its specified action(s) are executed by the interpreter. Rules govern when and if a request results in an action. In addition, the firing of a rule may create more requests.

Although an object may never move from the workspace in which it was created, an object may communicate with any other objects in its workspace or in any other running workspace in the computing system (i.e., all computers in the network). For example, in FIG. 1, object 2 of workspace 109 may communicate with itself; with object 1 in the same workspacel with object 5, in the same computer station but a different workspace 111; or with object 6, which is implemented in workspace 113 in computer station 103.

Each workspace contains an interpreter 407, implemented using, for example, the Java language and runtime environment. (It should be noted that an interpreter may be implemented in any other suitable programming language, as well, or even as a hardware machine, or in some other hybrid form. Because objects, workspaces, and interpreters interact by exchanging request messages in a common protocol, different interpreters in the same system may be implemented in different ways, and yet still interact freely with each other.) Each workspace interpreter 407 references the workspace's object list map 405, the “oblist”. An interpreter 407 may regulate delivery and implement execution of requests 409 which are addressed to objects in the workspace with the use of pathstrings, which will be discussed in detail later. The interpreter may take requests for processing from two separate queues, the first being a Loop-Around Request Queue 413, and the second being an Input Request Queue 411. An Output Queue 415 is also implemented in a workspace to manage outgoing requests to other workspaces. The interpreter uses Request Queues 411 and 413 to hold requests to be processed. Generally, new requests enter the end of a queue, and the interpreter removes requests from the front of the queue to process them, thus implementing a “fifo” or “first-in-first-out” queue. As the interpreter processes a request, for example from the Input Queue 411, a path follower 407-c directs the request to addressed objects by interpreting a pathstring, which is a string that is part of the request, and which will be discussed in detail later. The pathstring may direct the interpreter path follower to route the request through a series of intermediate objects, generally indexes, which direct it on its way. The ultimate destination of each request is one or more target objects. Once a request reaches a target object, the interpreter uses a software pattern called a “request visitor” (or visitor algorithm—see below) to invoke the appropriate method in the request processor 407-a to handle the request according to its type. The request processor 407-a directs the process called a frame, which determines how the request operates upon the object receiving it. The request processor determines which fields in the target object are affected, and how they are affected, and thus which rules in the object may potentially fire. The request processor 407-a then uses a rule processor 407-b to process those selected rules. The rule processor 407-b deciphers each such rule, and causes the rule to “fire” when its conditions are met. When a rule fires, it may take actions, which may include evaluating conditions, editing the incoming request, generating new requests, and aborting the frame. Note however, that while requests may cause changes to the state of an object, and rules may edit the contents of a request, rules generally have no way to directly alter the state of the object. In order for a rule to initiate change to its underlying object—or any other object—it must generate one or more new requests to make such changes. This prohibition of direct changes by rules to the state of the object prevents rules from directly triggering additional rules during a frame. If rules could trigger additional rules during a frame, it could easily result in cascades of rules firing that could be difficult for programmers to anticipate and control.

Request Processing—More Detail

Loop-Around requests, or “minor” requests (i.e., requests in a Loop-Around Request Queue 413), also called shortcut requests, are requests from an object addressed to itself. Therefore, during the process of a frame, an object is capable of sending requests to alter or obtain data from itself via the Loop-Around Request Queue. An interpreter preferably processes requests sequentially off the Loop-Around Request Queue; therefore, an object may only receive requests from itself one at a time. Since requests in the Loop-Around Request Queue are processed before any other requests, it allows an object to complete a series of operations on itself without being interrupted by unrelated requests from other objects, which would arrive via the Input Queue.

Request Queues, in particular Loop-Around Request Queues may carry extra “context” information for the interpreter, for example the state of temporary variables and arguments, to allow an object access to this information in subsequent frames in a series of operations within one object.

The Loop-Around Request Queue has the highest priority in the system. That is, when servicing an object, all requests in the Loop-Around Request Queue are processed before those from any other queue. Therefore, an object currently processing a frame will not be interrupted by requests dealing with a frame other than the current frame (e.g., requests from the Input Request Queue). A workspace may contain one Loop-Around Queue used to service all of the requests, or alternatively, each object may contain its own Loop-Around Queue used to process the minor requests of the associated object only.

Input requests, or “major” requests, in Input Request Queue 411 are requests sent from one object to another. The use of the “frame” mechanism manages “ownership” of an object while a request is being processed for the object, and allows a computer station with multiple processors to concurrently process, off an Input Request Queue, without collision, requests for different objects, even in the same workspace. The Input Request Queue 411 contains requests arriving from adapters and from other objects, remote or local.

For a given object, no requests in the Input Request Queue are processed until all requests in the Loop-Around queue have been processed. Therefore, if a request is being processed relative to an object, the Input Request Queue effectively will be restricted until the Loop-Around Request Queue has completed. This restriction prevents the object in question from being processed in new frames before its current frame has completed. A workspace may contain one Input Request queue used to service all of the major requests, or alternatively, each object may have its own Input Request Queue used to process the major requests of the associated object only.

If a single rule in a single frame addresses more than one request to the same destination, preferably all these requests are packaged into a special kind of request, known as a compound request, and placed onto the Input or Output Request Queue 411 and 415 respectively as a unit. These bundled requests travel together in the system and on networks until they reach their target object destination. When received, the requests contained in the compound request are processed in the same order in which they were sent, and without being intermingled with other unrelated requests from the Input Request Queue.

Each compound request may be thought of as a special sub-queue of the Input Request Queue, with priority above the general Input Request Queue 411 but below that of the Loop-Around Queue 413.

There also exists an Output Request Queue 415 which is responsible for sending requests to other workspaces. For example, if a rule associated with an object is fired and causes a request to be sent to an object in another computer station, that request is first placed in the Output Request Queue 415. A module of the interpreter known as the transmitter removes items from the Output Request Queue 415, establishes a communications link to the appropriate destination workspace, and sends the request to the Input Request Queue in that workspace. The transmitter may locate each desired destination workspace by using a workspace registry or a network “naming service” such as “Bonjour” from Apple Computer, Inc. The transmitter, and corresponding receiver at a destination station, preferably use a communications protocol such as TCP/IP to provide communications services such as error checking and correction, address translation, message routing, end-to-end message acknowledgment, hardware interfacing, and so on. These services are commonly referred to as the “IP Stack”, which includes software and hardware layers. The art of computer networking is well known. See, for example, the book “TCP/IP Illustrated Volume 2—The Implementation” by Gary R. Wright and W. Richard Stevens, published by Addison-Wesley Professional, 1995, ISBN 0-201-63354-X.

Adapters

A workspace may also contain one or a variety of adapters. Adapters are objects with special capabilities that allow the workspace and objects in the workspace to communicate with the “outside” world by transferring information between external systems and objects in the workspace, in either or in both directions. Typically, an adapter is configured for a specific communication situation. A few examples of adapters include, but are not limited to: email adapters used to send or read messages to or from an appropriate mail server; file adapters used to read records or lines of text from a file or to write records or lines of text to a file in the file system of the computer; a Java database connectivity (JDBC) adapter used to access an external data source using the JDBC mechanisms; a simple object access protocol (SOAP) adapter used to access web services; a time adapter used to schedule actions to occur either on a regular repeating interval, after a set amount of time has elapsed, or as a scheduled event; a uniform resource locator (URL) adapter used to read and write content using standard URL syntax. A URL adapter is typically used to read and post to HTTP servers, although other protocols, such as FTP, are supported. A workspace may also communicate with the outside world through requests sent and received directly, in proper form, to or from a source which implements a protocol compatible with the request protocol. Requests and adapters are two ways workspaces communicate outside the system. A typical adapter consists of two parts, an inside part and an outside part. The inside part exists in a workspace and appears to be an ordinary object with fields and values and rules. The outside part is a computer program module implemented in a computer language such as Java or C++. The two parts of a given adapter run asynchronously relative to each other. Just as any other object in the workspace, the inside part receives requests, but unlike an ordinary object, it translates some of these requests into work tasks, such as reading a line from a file or sending an email message to a server. It places these created work tasks into a dedicated queue that delivers work tasks from the inside part of the adapter to the outside part. The outside part asynchronously receives these work task items, and interprets them to determine what work needs to be done. The outside part then does the requested work, which may require an extended period of time; for example, to send a request on the Internet and wait for the response. Waiting for such work to complete would not be possible for one of the ordinary objects to accomplish because objects in the example system must always operate within a frame, and frames are not allowed to wait. Once the outside part of the adapter completes a task, or at other times, it may be designed to send results and/or status information back to the requesting objects, or to other objects in the system. It sends this information by composing one or more requests and placing them into the Input Request Queue for the workspace if they happen to be addressed to the present workspace, or into the Output Request Queue if they happen to be addressed to other workspaces. Thus the two halves of an adapter run asynchronously and always communicate with each other using queues.

Every adapter is implemented as a computer program, for example using the Java programming language. The Java compiler produces “class files” which contain the compiled instructions, called “byte codes”, for the program; and there are similar files, sometimes referred to as “object modules”, produced by other languages. The system may be arranged so that if these programs and resulting files are created according to a predefined structure and pattern, they may simply be placed into a well known file directory in the computer where the workspace runs, and the interpreter running there will recognize these files and cause them to be automatically installed as adapters available in the workspace. Thus, it is simple to create and install new adapters to be used by a workspace UI:

FIG. 4 also depicts a detailed schematic of a UI 417 which may be employed to advantage with such a system. A UI allows the user to send and receive requests 409 via (for example) a BIOS device 419 (e.g., screen, keyboard, mouse, voice input, etc.). Within the computing system, a UI 417 acts as a pseudo workspace. In other words, the rest of the computing system views the UI as another workspace able to send and receive request messages 409. UI 417 might not contain objects, only programming code which sends and receives request messages 409 to and from other workspaces and which communicates with BIOS devices. The function of the UI is independent of the computing system, such that if the UI were to malfunction, any associated workspace(s) will continue to operate.

A UI may use a “visitor” algorithm such as a path visitor 421 and request visitor 423. A visitor functions like a switch which enables a same command to be defined differently in different components of the computing system. For example, a request visitor in the interpreter 407, may perform certain operations when a ‘set’ request is received, wherein the UI may perform different operations for the same ‘set’ request. Each of the different types of request may have a visitor associated with it in the interpreter and UI. The Visitor Pattern is well known in the art of Object Oriented computer programming.

An example of a request being processed by a UI is as follows, although the invention is not intended to be so limited. For example, a rule firing in an object in the system may send a request 409 to a UI to edit an object via a BIOS device (e.g., the computer screen) 419. The command “edit object” may be encoded in the path itself, as part of the request to the UI; or alternatively, it may be encoded in the body of the request. Inside the UI, the request 409 is sent to a path visitor 421 which will resolve the pathstring according to a process defined by the UI. Thus, this particular path causes the path visitor to send the information in the request to a module in the UI which implements the “edit object” command by making the desired object editable on the screen. Once a pathstring has been resolved by the path visitor in the UI, the request may be sent to a special request processor 423. The special request processor 423 may be used for requests pertaining to the UI, for example: EditObject, CloseForm, message requests, and email requests, which will be discussed later. If the object has been flagged in the UI as an object of interest, the object may be stored in the object mirror cache 425. Storing objects of interest in object mirror cache 425 reduces network traffic as cache 425 eliminates the need to retrieve data repeatedly from the workspace 401, but this cache is entirely optional as the UI could simply request a new copy from the workspace of any object whenever it needs it. The object mirror cache 425 may use listener rules, as described earlier, in order to be informed of any changes that occur to the underlying object in the workspace 401, thus allowing the cache contents to remain in sync with the actual object contents. The UI model 427 is used to present the object in viewable form with the use of form objects. The UI windowing 429 is used to transfer an image of the object to screen 431. UI 417 as well as workspace 401 are capable of communicating outside of the computer station in which they are implemented with the use of network connections 433 and 435.

The UI may be used to display objects and their fields in various ways, but preferably as forms. A form displays data from an object, or a group of objects, in a window on a computer screen, and may provide ways of interacting with that data. Each form is itself described by a form object in a workspace, containing details of how the form looks and what it does. Form objects are ordinary objects which contain information which specifically directs the UI to display other target objects in a particular way. A form object may contain information about sizes, positions, fonts, colors or methods of display (e.g., text, list, label, button). Any object may include a reference to a form object, thereby causing the UI to display the object's contents, when requested, according to the description in the referenced form object. In some cases, for example, there may be stored a reference to the preferred form for a UI to use to display or edit an object as a special field in the object itself; this field may be called, by convention, “s.form”. An object may reference more than one form, and thus may be able to be displayed by the UI in more than one format. Additional forms may be referred to using fields in the object itself; for example fields called s.form1 or s.form.managerview. These “s.form” fields would have as their value the GUID of a form object the UI should use when displaying the underlying object. The UI, or other software, may provide editor tools for creating and editing these form objects; for example, placing and sizing fields to display text. One very convenient embodyment of such a form editor is a “What You See Is What You Get” (“WYSIWYG”) editor where users select items such as display fields and buttons from a pallet of possibilities, and drag them to their final positions and sizes on a displayed model of the target form.

A user may send various commands as requests to the UI to view or modify object forms. The implementation will determine the commands that are available and this invention is not limited to a particular command set. Nevertheless, some examples of useful commands will be provided.

A command called EditObject (or similar) preferably is included in a system according to these teachings and may be used to display either an object view or a form view associated with the given object. When using the EditObject command, a user preferably will be able to see an instance of a form on a computer screen. This open object is then called the base object. The form may display information from the base object and from any other objects. Many objects may share the same form, which means each one is shown in the same format when viewed. On the other hand, a single object may be viewed using multiple forms, so that it may be seen in different ways, depending on the form used to open the object. A command called CloseForm (or similar) preferably is included in the system and is substantially the opposite of the EditObject comand, in that the command CloseForm may be used to close the specified object as displayed by the specified form.

Pathstrings:

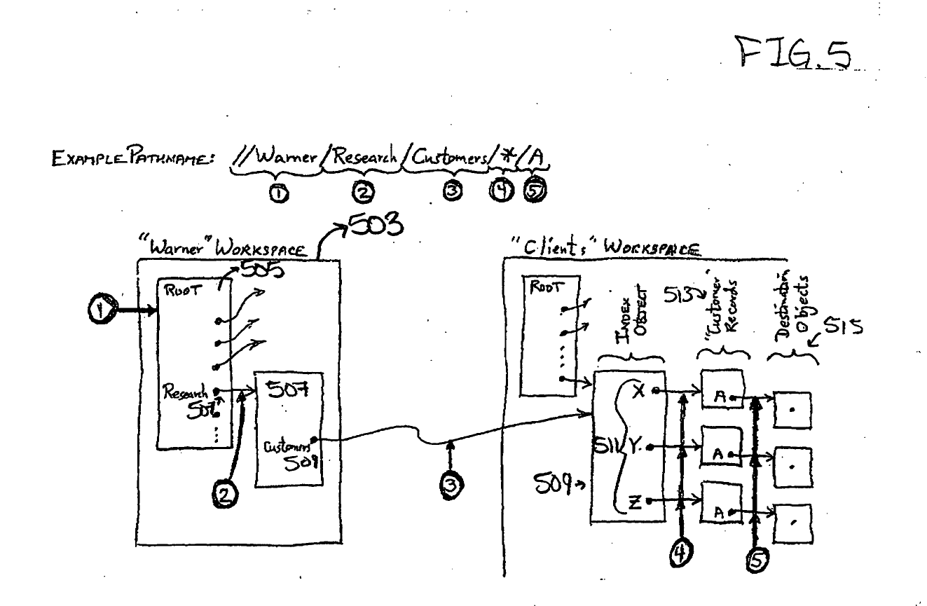

Practically all events which take place in the computing system discussed herein are the result of receiving request messages at destination objects. Requests may originate from any object in the system, from a UI, or from other applications which create messages that are compatible with this system. Consequently, each object which can receive request messages must be addressable. The primary address of each object is its GUID. Other suitable addressing schemes may also be used and pathstrings (sometimes called “pathnames” or simply “paths”) are one useful scheme. As shown herein, pathstrings are used to address messages to any objects in the system. FIG. 5 illustrates the use of pathstrings for addressing.

As the name implies, pathstrings are strings of characters. Pathstrings are contained in requests and are processed to move the requests which contain them toward their respective destinations. In one implementation, each pathstring is composed of one or more elements which are interpreted sequentially (left to right) to direct its containing request, step by step, to its desired destination or destinations.

It is useful if the first element of a pathstring may be interpreted differently from the subsequent elements (but not required). For example, it is useful for the first element to specify a starting location, object, or context for interpreting the remainder of the pathstring. For instance, a pathstring beginning with a double slash (‘//’) may mean that the key following the double slash is the name of a workspace where the next element of the pathstring should be interpreted using the root object of that workspace. A single slash may mean interpretation of the path should start at the root object in the current workspace. No slashes might mean interpretation should start with the current object, i.e. the object issuing the request. The first pathstring element may also be the GUID of a specific object, designating that object as the location where interpretation of this pathstring begins. In every case, there is always an explicit or implied starting object where the pathstring begins its interpretation (see the first point in the general outline, below).

A delimiter such as the slash character (‘/’) may be chosen to separate the elements of pathstrings. Each pathstring element is processed by a portion of the interpreter known as a Path Follower, which in one implementation is a Java class object with methods for interpreting the different sorts of elements which may appear in a pathstring.

There may be many kinds of pathstring elements. A pathstring element may be simply an alphanumeric string, known as a “key”, or it may be a more complex syntactic/semantic structure which gives information about how to route the containing request toward its destination(s).

In addition to each pathstring element, an object where the pathstring element is processed, known as an index object, also participates in the interpretation process, as described below.

A general outline for processing a pathstring element using the Path Follower, as an example, is as follows:
1. A request containing a pathstring arrives at an object. If all the elements of the pathstring have been processed, this object is the final destination of the request, and a frame is started to process the request on the object. If there are more elements in the pathstring, then this object is called the “index” object for interpreting this pathstring element.
2. The Path Follower interprets this next element of the pathstring using information from the pathstring element and from the index object. The results of this interpretation is the GUID of an object (or a set of GUIDs for a number of objects) which will be the next object(s) in the path of this request. See below for some of the ways this interpretation may be usefully accomplished.
3. The pathstring element which was interpreted in the preceding step (or act) 2 is removed from the pathstring, and a record of its interpretation, including for example the text of the element and the resulting GUID(s), may be appended to the request for debugging and other purposes.
4. For each GUID resulting from step 2, an instance of the request is forwarded to the object addressed by that GUID. If there was only one GUID, then the request itself may be forwarded, but if there was more than one, an independent copy of the request must be made for each. Each instance is forwarded by looking at the associated GUID, and, if it is of the current workspace, placing the request instance into the input queue for this workspace; otherwise, placing the request instance into the output queue, from which the transmitter will send it to the input queue of the appropriate workspace where the GUID may be found. Once forwarded, each instance of the request continues independently at step 1, above.

Step 2 above may be accomplished in many useful ways, depending on the contents of the pathstring element and the contents of the index object. The most basic is a simple key lookup, where the pathstring element is an alphanumeric key, and the index object contains index fields which map keys to GUIDs. In this case, the Path Follower may look up the key from the pathstring using the index fields and return the corresponding GUID value, or declare an error if there is no such matching index field. The following list includes examples of many of the useful forms in which pathstring elements and index objects may be processed to generate a GUID or set of GUIDs for step 2 above; however, many more forms are possible and useful:
1. Simple key lookup: As described above, the pathstring element may be a key consisting of an alphanumeric string, or a “protected string” (see below) containing alphanumeric characters and/or non-alphanumeric characters. Such a key may be interpreted by looking it up among the index fields of the index object, and when it is found, returning the GUID value associated with that index field. The system may declare an error if the key is not found among the index field names, or if the index field which is found does not contain a valid GUID value.
2. General wildcard: A syntax, such as an asterisk character (‘*’) for example, may indicate that all of the index fields in an index object are to be used and their GUIDs returned. The general wildcard may allow modifiers to follow the asterisk, such as ‘>’ and an alphanumeric key, to indicate that only index fields whose keys are greater than the supplied key are to be used. Similar modifiers for other relationships such as “greater-than-or-equal-to” (‘>=’), “less-than” (‘<’), and “less-than-or-equal-to” (‘<=’) may be allowed. A modifier such as a number-sign (‘#’) may be allowed in addition to indicate that the preceding comparison should be done numerically rather than as strings. A modifier such as a number in square brackets (‘[n]’) may be allowed to indicate that at most that many (i.e. n) index fields and GUIDs should be returned; or a pair of numbers in square brackets (‘[m,n]’) may indicate that at most n index fields and GUIDs should be returned beginning with index field m.
3. Regular expression wildcard: A syntax including a regular expression (see, for example, the book “Mastering Regular Expressions, Second Edition” by Jeffrey Fried1, O'Reilly Media, Inc., 2002, ISBN 0596002890) may be used to indicate that only index fields whose keys match the supplied regular expression are to be used and have their GUIDs returned. The syntax may include extra characters, for instance enclosing parentheses around the regular expression, to distinguish this syntax from the syntax of other element types. The same modifiers as described in the general wildcard case may also prove useful in this case.
4. Range keys: A range key is a kind of pathstring element which returns only one GUID, and it is similar to a simple key, but it does not require an exact match of the supplied key. For example, a range key may match the one key in an index which is “less than or equal” (or any other desired relationship) to the supplied key. The range key form is useful when one wishes each index field in an index to match a range of possible keys from pathstrings. Thus, a beginning date key in the index could match all supplied dates which fall after it, up to the next date key in the index. Each index field in the index might thus represent the start date of a range of dates that runs up to the next following index key. Arbitrary ranges can thus be easily represented by the index keys in an index object. Two forms of range key are usually required, one for string comparison ranges, and one for numerical comparison ranges. The syntax of a range key in a pathstring may be simply a relationship operator (e.g. ‘<’, ‘>’, ‘<=’, ‘>=’) followed by the key value itself. A modifier (e.g. the character ‘#’ preceding or following the relationship operator) may indicate a numerical comparison is to be used rather than a string comparison.
5. Soundex keys: A syntax may be provided, for example a preceding special character such as a tilde (‘˜’) before an alphabetic key, to indicate that a soundex algorithm (for example, see U.S. Pat. No. 1,261,167) should be used to match the provided alphabetic key with the index field keys in the index, and return the GUIDs associated with all index field keys which match. Other algorithms related to soundex might also be made available, such as the LEAA codes used in crime prevention databases, or the Cutter Tables used by libraries to encode author names. The idea of all these algorithms is to allow matching based on other criteria, such as how a key sounds when spoken, rather than its exact spelling. It is easy to see that other “fuzzy” matching algorithms may be provided in a similar way.
6. Processing the pathstring element by the index object: The index object may indicate, using a technique such as the presence of a special field (e.g. a system field with a particular name such as “s.special.lookup”), that the index will provide special behavior for processing pathstring elements. It may provide this behavior in the form of rules, code, procedures, patterns, or other programming.

When a Path Follower applies a pathstring element to such an index, it may execute the behavior routine from the index instead of or in addition to its normal processing for the element. The result, as in all cases above, is one or more GUIDs of objects to which the request will be forwarded. Such special processing allows an index to be an active forwarder of requests, allowing for example, the use of hash tables or any other mechanisms to compute the next destination(s) along the path. Different processing options within the same index might be indicated by using different special field names within the index.

An example is pathstring 501://Warner/Research/Customers/*/A. Here, the pathstring directs a request from anywhere in the computing system to the workspace called “Warner” (503). Within the workspace Warner (503), the request message is sent to the object root (505) containing index fields for the start of the tree in this workspace. The message is then directed to an object indexed here as “Research” (507). The term “Research” is a lookup key used to link through the index fields to another object. From the “Research” index object the message is sent to an object indexed as “Customers” (509). The object indexed as “Customers” is found in a workspace named “Client” (515). The next element in the pathstring is “*”, which is a wildcard indicating all objects within the index—i.e., broadcast to all index fields found in the object indexed as “Customers”. In other words, an attempt to send a unique copy of the request will be made to all the entries 511 (“X”, “Y”, and “Z”) in the Customers index 509. When it receives the request, each of these objects uses the Path Follower to look up key “A” 513, which is the next element in pathstring 501. Lookup key “A” directs the message to each object which is associated with that particular key in each of the objects “X”, “Y”, and “Z”. “Warner”, “Research”, “Customers”, and “A” are all considered keys, and each of these, along with the wildcard “*”, are elements of the example pathstring 501.

Keys direct a message to an object indexed as the key by the pathstring. A key refers to a particular forwarding address within an index. Different keys in the same index may direct a message to the same address; therefore, the same object may be referred to by different names (i.e. keys). Any number of indexes may refer to the same object. An object may be indexed under many different keys. Therefore, an object need not have a unique name, only a GUID which distinguishes the object from other objects in the system.

////Warner:2132

Ordinary objects may be used as indexes. By convention, as shown earlier, user defined fields in objects may begin with a selected code, such as the characters “u.”, therefore u.x is the user field “x”. Since all index entry fields in an index are a subset of the user defined fields, they may be named, for example, as follows: u.i.<key>. The value of an index entry field is the GUID value of the object associated with the key and thus the name of the index field. For example, the index field named u.i.smith may have a string value of “Warner:35”. In this way, the index contains the GUID for the object which is associated with the key “smith.” Simply having a “u.i.” field makes an object an index. Any field in an object may also act as an index without the “u.i.” prefix, such as, for example, a request containing the pathstring//Warner/u.xx. This pathstring begins with a workspace name and contains a field named u.xx which contains a GUID value.

Each object may also contain a field which contains the GUID of its parent index. Every object may keep track of the location of the index where it was first created and indexed; all objects have this history since all objects are created as part of a tree. Thus, the parent index is a pointer up the tree and towards the root. Therefore, one may create a pathstring which refers to the parent of the object using the parent index. A pathstring may be created which includes multiple levels of parent indexes, for example, to reach “the great grandfather” of an object. If the field referencing the parent index is called “s.ParentIndex”, then the path to the “great grandfather” might be “s.ParentIndex/s.ParentIndex”. It is convenient to have a shorthand for the parent index, for example, two periods; thus, the preceding path might be written simply as “../..”.

An object may create a pathstring referring to itself, so that it can send a request to itself. Such a pathstring is called a self-reference. For example, a self-reference pathstring may be simply an empty pathstring. Alternatively, since every object may have a field, e.g. “s.guid”, containing its own GUID, a self-reference pathstring may also be written using this field name, as, for example, ////ˆS.GUIDˆ/key “s.guid”. Recall that requests which are directed from an object to itself are to be handled in a special request queue called the shortcut queue. It is useful if there is a specific pathstring, for example the empty pathstring, which forces the request to be routed through the shortcut queue, as well as a different self-reference pathstring, for example “s.guid”, which allows the request to be processed in the normal input queue. Because the shortcut queue is the highest priority request queue, it is sometimes useful to force a self-referencing request to be processed without using the shortcut queue; for instance, when a long string of self-referencing requests in the shortcut queue could prevent other requests in the workspace from being processed for a long period of time, and the programmer wishes to give up control to allow other unrelated requests to be processed.

Protected key names in pathstrings may be used when it is desired to have non-alpha-numeric characters which may otherwise have syntactic and semantic meaning, such as parentheses, asterisks, slashes, etc., in a pathstring. By enclosing the affected key in single quotes (‘), (for example, or another chosen delimiter), the Path Follower can be prevented from seeing and acting on these characters. Protected keys are useful when one might not know what characters a key contains. For example, the key might come from an external source such as a data file or user-typed input. The following is an example of a pathstring using protected keys, if a user wishes to create an index command strings, one of them being “*>xxx”. Unprotected, the Path Follower would interpret such an element in a pathstring as a wildcard. If it is protected by surrounding it with single quotes, as ‘*>xxx’, it will be correctly seen as a simple key consisting of the five characters “*>xxx”. It is useful to have a way of escaping special characters in a protected pathstring element; for example, if the programmer wished to include a single quote character within the protected string. There are many character “escape” techniques known to the art, for example preceding the escaped character with a special escape code character, such as a backslash (‘\’). Naturally, if one wishes to include the escape code character itself within the protected element, the escape code character must itself be preceded by the escape code character (in effect, doubling the character, as “\\”).

Rules

Rules are instructions a user may write and attach to individual fields of an object, or to the entire object itself. Any field, or object, may have any number of rules attached to it. A rule placed on a field may apply only to that field, and not to any subfields which that field may have, or it may conditionally apply to the subfields. Rules are independent of one another, and when they fire during a frame, there is no guaranteed order in which they are processed.

Rules are processed only when a request affects the field where the rule is attached; or the object as a whole, if the rule is attached to the object field. A rule runs when its on-condition (i.e., the condition under which it fires) matches selected information, such as the type, of the incoming request. For example, a rule beginning “on (set)”, where “set” is the on-condition, runs whenever a set request sets a new value in the corresponding field or object. In other words, a rule will only “wake-up” and be active when a request of the proper type arrives. On-conditions may take various forms, but they may depend only on the type and contents of the incoming request and the target object. It is useful to have on-conditions for each request type: “set”, “cr” (for create), “df” (for delete field), “ar” (for add rule), “rr” (for remove rule), “get” (for requests for information), “invoke”, and “workspace”; as well as on-conditions that represent more complex conditions, for example “change” which triggers when the attached field or object is changed by any kind of request. On-conditions are useful and powerful ways to control the execution of rules, while at the same time promoting efficiency by allowing the interpreter to avoid evaluation of rules that are not of use in a given situation.

When they execute, rules are only capable of seeing and responding to their immediate surroundings inside an object. They cannot directly pull any “remote” data from other objects. (But rules can issue requests to other objects for data.) A rule can be written to compose one or more new requests and send them to other objects, or to the object containing the rule itself. A rule may also decide to prevent its object from accepting the current request, giving an object the power to monitor its data fields and control access to itself. However, a rule is generally not capable of directly changing the object in which it resides, nor any other object, but can only issue requests which may cause changes later. An exception to this principle is that a rule is allowed to modify the contents of an incoming “set” or “cr” request, changing the values or the fields to which the request applies, or even adding or removing portions of the request. This request editing capability is important in enabling rules to maintain object security and integrity, and also to allow rules to establish semaphores that change state “atomically” within the same frame as an incoming request.

Rules preferably have a standard format, consisting of several parts. For example, the format may be: optional prefix characters; an “on” clause; an optional “guard” condition; and optional action clauses such as address setting, request generation, and conditional clauses and structures. Other formats may be adopted, but it is generally necessary to establish a convention.

Prefix characters may specify special processing, such as debug tracing, for example “*” and “@”. A prefix such as asterisk “*” (or other code) may be used in the beginning of a rule to indicate it is a temporary rule, usually attached by a UI. It is useful if temporary rules are not copied and they are not stored with the workspace when it is saved into a file. It is also useful if temporary rules always fire if their conditions are met, even if the object or field they are on has been otherwise inactivated.

An indicator, such as a single “@” prefix, (or other predetermined code) may be used in a rule to cause the interpreter to generate a trace report to a system console or log, whenever this rule is processed. A double “@@” (or other predetermined code) in a rule may cause the interpreter to trace every “flurry” generated by this rule. A flurry is this rule and any rules which fire anywhere in the system as a result of requests sent by this rule.

An “on” clause is part of a rule which specifies the condition, for example the kind of request, to which the rule responds—i.e., what triggers the rule to fire. Every rule must have an on clause. For example, an appropriate representation is “on(list-of-request-types)”, where the list-of-request-types is a comma separated list of request type-names to which this rule will respond. Request types will be discussed in further detail later.

An “if” clause, also called a “guard”, is one which specifies logical conditions under which the rule will execute. This clause is in the form “if(<expression>)” where <expression>may be any valid expression. If the expression evaluates to “true”, the remainder of this rule is processed, otherwise processing ends for this rule.

A “to” clause specifies where subsequent request messages will be delivered. The “to” clause is in the form “to([<path>])”, where the optional <path>is any valid pathstring according to the invention. If the “to” clause is given, but the optional <path>is omitted, it directs subsequent request messages to the present object, using the shortcut queue. It is convenient and useful if each rule begins with an implicit “to( )”; i.e. an empty “to” clause. There may be any number of “to” clauses in a rule; each one establishes a new destination path for subsequent request messages generated in this rule, until any subsequent “to” clause.

A “from” clause specifies that subsequent “set”, “cr” (create), and “invoke” requests, and perhaps others, in the present rule may be executed from another object rather than the current one. Executing them from another object causes them to use that object, rather than the present one, as the context and source of data for evaluating any expressions. The system accomplishes this remote request execution by packaging the text of the request to be executed remotely in the payload of a “get” request message, and sending that request to the <path> given in the “from” clause. When the target object of this “get” request receives it, it undergoes normal “get” request processing; for example, triggering any “on(get)” rules on the object. If there is no abort, the object receiving the “get” request then executes the payload as if it were a local rule; i.e. using all the fields and other information from that object. The destination of any requests generated by the “get” processing is the <path>, if any, which was set by a previously executed “to“clause in the originating rule (the rule that originally executed the “from” clause). If there is no such preceding “to” clause, then the destination of any requests generated by the get processing will default to the originating object. The “from” clause is of the form “from([<path>])”, where the optional <path>is any valid pathstring according to the invention. If the “from” clause is given, but the optional <path>is omitted, it directs subsequent request messages to be executed in the present object. Each rule begins with an implicit “from( )”; i.e. an empty “from” clause. There may be any number of “from” clauses in a rule; each one establishes a new from-path for subsequent request messages generated in this rule, until any subsequent “from” clause. This processing of the “from” clause is actually quite intuitive and easy to understand; for example, “from(/x/y) set a=b;” generates the “set” request in the object at the path “/x/y” and returns the result to the field “a” in the current object. The net result is that the value of the field “b” comes from the remote object at the path “/x/y” and is returned to the current object. A slightly more complex example is the following: “from(/x/y) to(/m/n) cr*:=*;” which generates the create request from the object at the path “/x/y” which causes a new object to be created at the path “/m/n”, which new object is a copy of the object (i.e., a copy of most of the fields of the object) at “/x/y”.

Return to, or “rto,” clauses specify where the results of any subsequent explicit “get” request in the same rule will go. This clause type is of the form “rto([<path>])”. It specifies a pathstring to the “return to” destination for subsequent “get” requests in this rule. When a “get” request is executed, its results will be returned to the location specified by the last executed “rto” clause in this rule, if any. In absence of an “rto” clause, or after executing “rto( )” (with an empty path), get results are returned to the object which initiated the get request. There may be any number of “rto” clauses in a rule; each one establishes a new return-to path for subsequent get request messages generated in this rule, until any subsequent “rto” clause. The “rto” clause has the same format and behavior as the “to” clause, except that it only affects explicit “get” requests' return results.

The “to,” “from,” and “rto” clauses are independent and do not affect one another.

It is useful to have a construct in rules which encapsulates the state of the path addressing clauses “to”, “from” and “rto”, so that a subpart of a rule which is so encapsulated may have its own values for these settings which are then restored to their original values at the end of the construct. For example, such a construct might be “do{ . . . }”, where the “ . . . ” portion between the curly brackets represents the encapsulated actions. Any “to”, “from”, or “rto” clauses contained within these curly brackets are canceled for all portions of the rule following the right bracket “}”, and the rule continues using the values of those parameters from before the left bracket “{”. This capability makes it easy to insert modular sections into the middle of rules, without upsetting the state of these parameters, simply by enclosing the inserted modular section within the “do{ . . . }” construct.

It is useful also to have a construct in rules which encapsulates portions of a rule to be ignored. For example, such a construct might be “skip{ . . . }”, where the “ . . . ” portion between the curly brackets represents the material to be skipped.

An “args” clause is used only with rules that fire in response to “invoke” requests (i.e., such rules begin with “on(invoke)”). It checks that required arguments are given and specifies any default values that may be desired. This clause may be of the form “args(<arg-list>)”. The clause specifies the legal and required arguments to the rule, as well as the default value of any optional arguments. If the “args” clause is omitted, the arguments to the rule are not checked, any arguments are accepted, none are required, and none may have default values. A specific example of an “args” clause is “args(x, y, z=13)”, which requires the arguments “x” and “y” to be supplied when the associated rule is invoked, and also makes the argument “z” optional, giving it the value “13” if another value is not explicitly supplied by the invoker.

If-elseif-else structures make parts of a rule conditional and cause parts of a rule to execute based on conditions. For example, if(<expr>){[<action>]*}[elseif(<expr>){[<action>]*}]*[else{[<action>]*}]. The <action>s following the first <expr> which evaluates to “true” will be the only ones which are executed. All other actions are skipped. If none of the <expr>entries evaluates to “true”, then the <action>entries following “else” will execute, if present. An if-then-else conditional structure may be placed anywhere in a rule where an action may be placed, including nested inside other conditional structures.

An iset (“immediate set”) statement is used to edit the incoming payload of a “set” or “cr” request (see below). The iset has the same syntax as a set request, but it has different behavior. Whereas a set request statement causes the rule to make a new set request message and transmit it at the successful conclusion of the current frame, the iset statement acts immediately to change the contents of the incoming “set” or “cr” request that triggered the present rule. In an iset statement, fieldname references are assigned the values of expressions which are evaluated immediately, in the context of the current object, including the glass pane (see below). Each assignment has the form “<fieldname-reference>=<expr>”. If the fieldname reference exists in the current request payload, it's proposed value is immediately changed to the value of <expr>. If the fieldname reference does not exist in the current request payload, it is added to the payload (and thus to the glass pane), and immediately given the value of <expr>. Since the changes made by iset statements apply only to the incoming payload, they will be made persistent in the object only if the current frame completes without aborting; otherwise, the changes are backed out just as are all other changes proposed by an incoming request.

“Let” statements create and give values to temp variables. Temp variables are created when necessary and exist only for the duration of a frame, and possibly for the duration of any subsequent minor frames from the shortcut queue. For example, let <var>=<expr>[,<var>=<expr>]*. Each variable <var> entry is created if necessary, and then immediately given the value of the expression <expr> following the equal sign. No requests are generated by “let” statements. “Let” does not affect the state of any object.

Temporary variables created in a rule exist only during the processing of that rule, and rules that fire as a result of requests that issue directly from that rule and are processed in the Loop-Around-Request-Queue. Temporary variables are useful when a single computation must be used many times within a single rule. For example, if one wants to generate a single random number and use it for multiple operations, one could assign it to a temporary variable. If instead of using a temporary variable, one were to call the random number function multiple times, one would get a different number each time, and that is not what is sought.

An abort statement causes the current frame to abort (end) and rollback any changes that have been made as if the current frame never occurred. The abort statement may cause a report of its action to be generated. The abort statement may include an expression which represents a string describing the reasons and context of the abort (e.g. a user error message), and this message may be included in any report which is generated. It may be convenient in some cases to have a form of the abort statement which aborts quietly, without reporting an error or creating any other report.

In structure, therefore, a rule is basically a string of characters which is attached to a field inside an object, or alternatively to the entire object.

Rules may include expressions to compute values for various purposes. One might use an expression to compute a new value and assign it to a field in an object. For example “set x=y+4” uses the expression “y+4” to generate a new value for “x”. An expression might generate a “true” or “false” value to act as the basis of a decision, for example “x<13”.

Expressions may only use fields from the current object or from the current request, args (if an invoke request), temps, the results of functions, and literal constants such as strings and numbers. Preferably, numerous operators and built-in functions are provided for use in expressions.

Expressions and their evaluation are familiar in many computer languages, and the art of creating, parsing, and interpreting them is well known. This invention uses expression forms that will be familiar to most people with experience in computer languages such as Java or C++.

It is useful if expressions in rules evaluate to string values, i.e. sequences of characters. The resulting strings may be interpreted in different ways, depending on how one wishes to make use of them. For example, an expression may evaluate to a numeric string representing the result of a calculation; for instance in the expression “y+4”, if the field “y” contains the string “3”, will evaluate to the new string “7”, which is the result of adding “3” and “4”. On the other hand, an expression such as “A && B” might evaluate to the string “true” if the values of both “A” and “B” are true, and otherwise to the string “false”. A further example is the expression “title # name”, where “#” represents the operator which concatenates two strings, which could evaluate to the string “Ms. Jones” if the value of “title” is “Ms.” and the value of “name” is “Jones”. All the results of these example expressions are strings, but they can be further interpreted to be numbers, logical values, or other strings.

Expressions may consist of references and operators. References supply the operands (i.e. the values to be operated upon) to expressions, and operators specify what to do. A few examples of references include name-references, including fields from the current object (e.g., u.name.first), temp variables, invoke arguments, numeric constants (e.g., 123 or 1234.56 or 123.45E-12), literal strings (e.g., “xyzzz”, including the quotation marks), predefined constants (e.g. true, false), function calls (e.g., min(x,4)), a parenthesized expression (interpreted as a reference to the value of the contained expression), or a rule literal composed of a rule enclosed in delimiters such as curly braces (e.g., {on (set) to (/Obj) if (x<=13) {invoke count;}}).

Name-references preferably are resolved by searching certain name spaces in a particular, predetermined order. For example: (1) if the name exactly matches the complete name of a field in the current object, the reference evaluates to the contents of that field, otherwise (2) if the name exactly matches a currently defined temp variable or an invoke argument, it evaluates to the value of that item, otherwise (3) if the name would match the name of a field in the current object if it were prefixed with “u.” or “s.”, then the contents of the corresponding u.name or s.name field supplies the value of this reference.

A special denotation such as a dot character “.” may be used in a reference as shorthand for the current field name to which the present rule is attached. A dot followed by more characters may be used to reference a field whose name is the current field name followed by a dot and those characters; for instance, in a rule on a field “u.x” the reference “.y” would be the same as the reference “u.x.y”. Multiple dots in a row may be used to indicate “going back” some levels of dots in a name; for example, in a rule on a field “u.x.y”, the reference “..” would be the same as “u.x”, and “..foo” would be the same as “u.x.foo”. Such “dot shorthand” may be allowed anywhere a field name is allowed.

Operators modify and combine string operands in an expression and take either one or two operands. Some operators, for example the arithmetic operators “+”, “−”, “*”, and “/”, may require their operands to be in a certain form, for instance numeric. An example of a one-operand operator is unary-minus (“−”), which negates its operand and therefore requires an operand with a numerical value. If a numerical value is not provided an error may be reported and the frame may abort. Another example is the not operator (“!”), which takes a string as its operand and reverses a value of “true” or “false”.

Examples of two-operand operators are concatenate (“#”), add (“+”), subtract (“−”), multiply (“*”), divide (“/”), modulus (“%”), AND (“&&”), OR (“∥”), and the comparison operators (“>”, “<”, “<=”, “>=”. “==”, and “!=”). All these operators, except concatenate, AND, and OR, require operands with numeric values, or else they report an error and cause an abort of the current frame. Concatenate, AND, and OR accept any values in their operands. AND and OR interpret, for example, any string beginning with the character “t” (case ignored) as the Boolean value true, and any other value as Boolean false.

Operators are applied in order according to the conventional rules of precedence. First, parenthesized expressions and the arguments of function calls are evaluated. Next, unary-minus and not are applied from right to left. Next, multiply, divide, and modulus are evaluated from left to right. Then add, subtract, and concatenate are evaluated from left to right. Next, any comparison operators are evaluated from left to right. Finally, at the lowest precedence, any Boolean operators (AND and OR) are evaluated from left to right.

The interpreter 407 “short circuits” the Boolean operators AND and OR, when possible. If the left hand operand of any AND operation is false, then the right hand side is not evaluated. If the left hand operand of an OR operation is true, then the right hand side is not evaluated. When not evaluated, the right hand side is completely ignored, operands and functions are not referenced, and macros are not expanded. Short circuiting ignores everything up until the next differing operator at the same precedence level as the AND or OR. No errors are generated even if otherwise there would be errors in the skipped part of the expression. For example, in the expression “1>2 && x<min (y,4) && truely”, the value of the expression is “false”, and nothing is evaluated after the first “&&” operator. No error is generated by the misspelled “truly” in this example, because it is not evaluated. It is important not to generate errors in the skipped parts of the expression so that expressions may be written which ignore invalid or missing operands.

The comparison operators require numeric operands and compare them assuming they can be interpreted as numeric values. If a user wishes to compare general (non numeric) strings, functions such as equals(string1, string2), compare to(string1, string2), and empty(string) are provided. This allows us to apply different comparison procedures to strings representing numbers than to other strings. For example, when compared as numbers, “10” is greater than “9”, but when compared as character strings, it is less because the character “1” is less than the character “9”.

For operands or functions that take Boolean (true/false) values, we preferably establish a convention such as any string which begins with the character “t” or “T” is considered to be true, and any other value is considered to be false. All functions and operators that return Boolean values may by convention generate the string “true” for true and “false” for false. It is useful to allow the identifiers “true” and “false” to stand for the predefined constant strings “true” and “false” respectively.

At any point in the text of a rule, the author may specify a macro substitution to be made. The form is an expression surrounded by distinctive delimiters such as up-arrow characters, “ˆ<expression>ˆ”. A macro may occur anywhere, even in the middle of a reference such as a name, or within a quoted string. When the rule processor encounters the leftmost “ˆ” character, it evaluates the following expression up to the next “ˆ” character, and then substitutes the value of the expression for the two up-arrows and everything in between. Macros are evaluated recursively, such that if the <expression> of a macro reference evaluates to a string containing another macro reference within it, that macro will be processed in the same way, and so on. An example of a macro is as follows, if the field “foo” contains the string “abc”, then the statement “set ˆfooˆ1=12;”is equivalent to the statement “set abc1=12;”. In one embodiment, macros are recognized and evaluated before most other processing; thus, macros may be substituted practically anywhere in a rule, such as into a quoted literal string or the name of a field, or even as the operator of an expression, or as an entire expression. The only places identified so far where macros are not recognized and processed when a rule is interpreted are 1) In the “short-circuited” portions of a boolean expression; 2) In the non-executed portions of a conditional construct such as if-elseif-else; and 3) Under the influence of a “skip” action, “skip{ . . . }, which instructs the interpreter to ignore whatever is within the curly braces.

Requests and Frame Relationship:

Every action which takes place in the system is a result of a message, known as a request, being received by an object. Request processing is handled by three layers, the first being a request navigation layer, sometimes referred to as a “path follower”. The request navigation layer determines where, among all accessible objects, the request must go. It may do this path following in a step-by-step manner, as shown in FIG. 5. For example, it may use an index to resolve a portion of the destination pathstring contained in the request, and as a result place the request into one of the request queues to move it along toward its destination. The second layer in request processing is the request processing layer, which removes requests from various request queues, begins their interpretation in a frame, and moves any rules which fire to the rules processor. The third layer in request processing is the rules processing layer, which executes rules, taking whatever actions the rules require, possibly generating further requests.

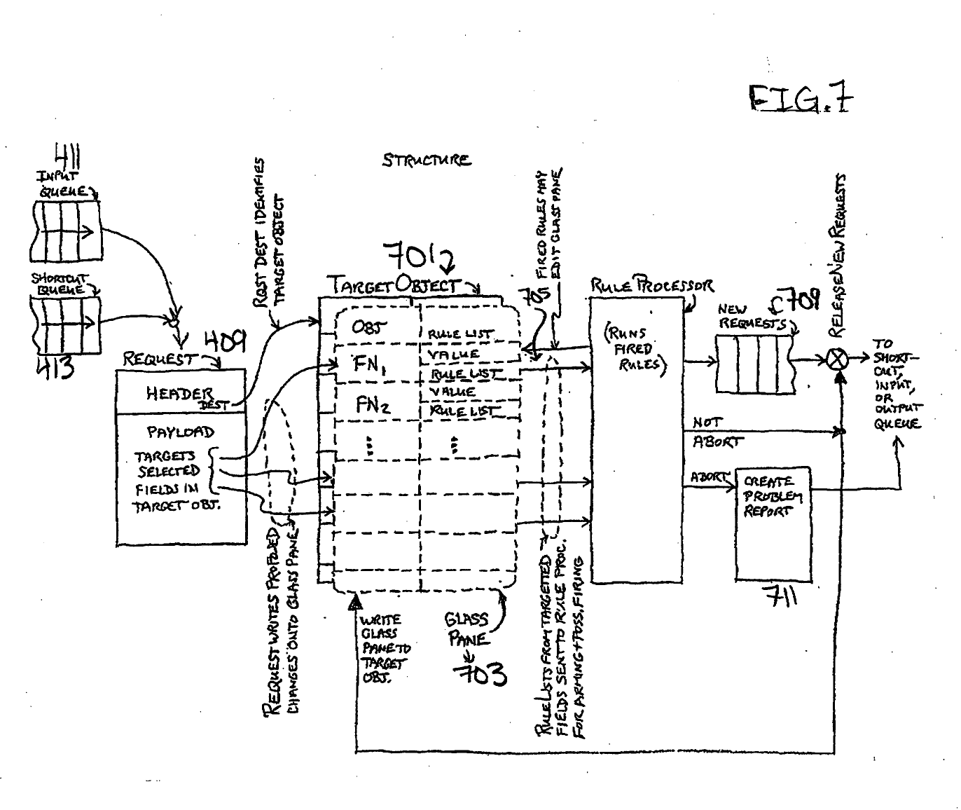

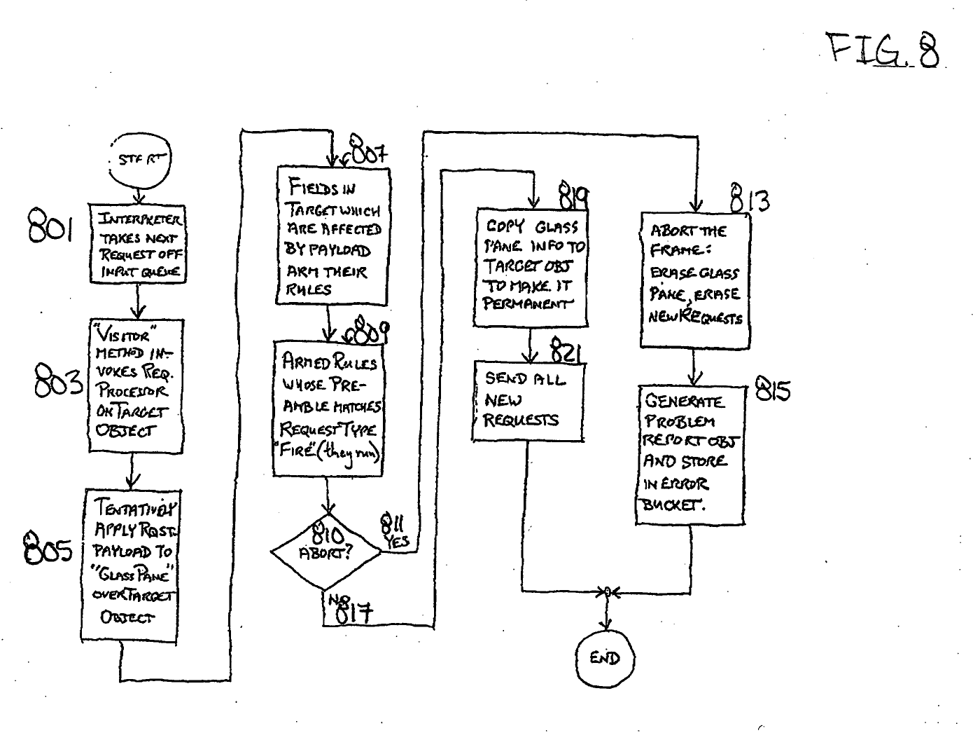

The entire process or mechanism of an object receiving a request message and dealing with it is called a “frame.” A frame defines or establishes a (variable) period of time over which a single request is being processed. The processing during a frame is depicted in FIGS. 7 and 8. FIG. 7 provides an illustration of the architecture and FIG. 8 provides a corresponding process flow diagram.

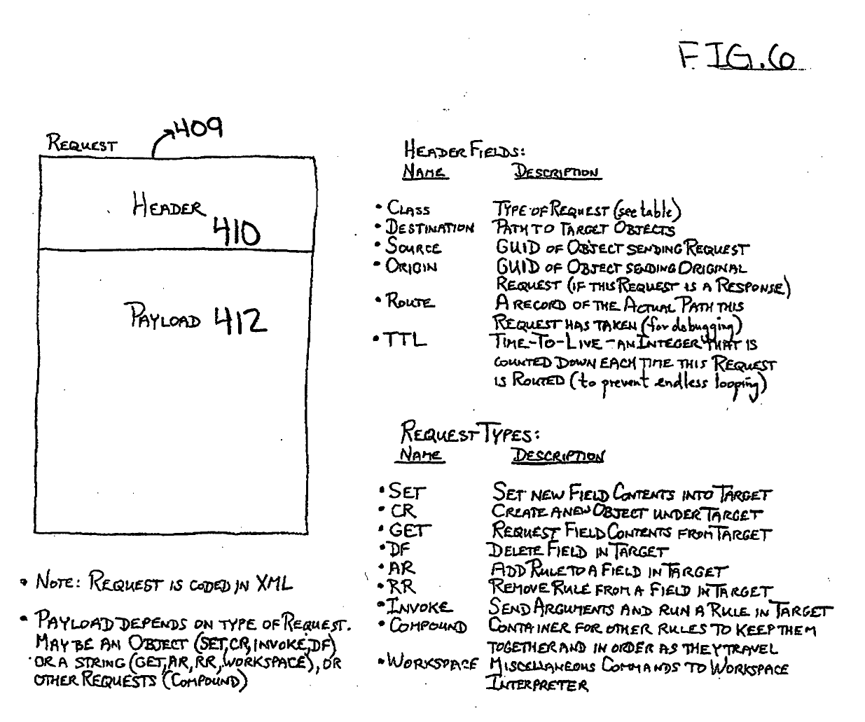

FIG. 6 depicts an example of a request structure according to an embodiment of the present invention. A request 409, which may be programmed in a variety of programming languages but in the example discussed herein is programmed in Java, is a data structure which has a header 410 and a payload 412. The header 410 includes information such as (but not necessarily all of, and not excluding other content) class, which denotes a type of request being made; destination, which is the identity of the target object, possibly represented as a path; source, which is the GUID of the object sending the request; origin, which is the GUID of the object giving rise to the request if the request is a response; route, which is a record of the actual path this request has taken (used mainly for debugging purposes); and TTL, which is Time-To-Live, an integer that is counted down each time this request is routed, in order to prevent endless looping.

The contents of a payload 412 will depend on the type (class) of request which is being sent. A payload may include, for example, an object (e.g., in set cr, and invoke requests), a string (e.g., in get, ar, and rr requests), or other requests (e.g., in compound requests). Each request message has a class or type associated with it which describes the requested action. Most requests convey only a single kind of operation; if an action requires more than one request, multiple requests may be bundled into a compound request, which guarantees they arrive together as a group at their destination and that they will be processed in the same order in which they were generated.

A “set” request proposes changes to the contents of fields in objects. A “set” request may also propose creation of new fields and may propose copying rules, groups of fields, and even the contents of whole objects from one object to another. If a targeted field does not exist in the target object when a set request is received, the set request will attempt to create the field before setting its contents. The source of information for a set request is by default the present object sending the request, but may be set to any other accessible object by giving a path to it in a “from” clause most recently executed before the “set” in the same rule. The destination of information from a set is by default the present object, but may be set to any other accessible object by giving a path to it in a “to” clause most recently executed before the “set” in the same rule. In the same way, in all the following requests described below, reference to “a preceding ‘to’ clause” or equivalent means the most recently executed example of that type of clause in the same rule.

A “get” request asks for information from a target object which is specified by a preceding “to” clause. The expressions in a get request are evaluated when the get request is received by a target object in a new frame by the interpreter for the target object, and the resulting fields are then requested to be set appropriately by a new “set” request from the target object back to the current object that originated the get request, unless an rto clause has been included. In the latter case, the resulting “set” request is sent to the object referenced by the most recently executed rto.

A “cr” request is used to create new objects. A cr request is always directed to the location (i.e., an index object) where a new object is to be created, which is normally specified by a preceding “to” clause, but will create the new object under the present object if no such “to” clause has been given, or if the preceding “to” clause specified no path. The last step of the path in a preceding “to” clause may specify the key (name) under which the newly created object will be indexed. The index object, known as the “parent object”, where the new object is created may have a reference to a template object which specifies the initial fields and contents of new objects created within that index. In most other ways, a cr request is identical to a set request. As in “set”, the source of information for a “cr” may be specified using a preceding “from” clause. In the case where there is no preceding “to” clause or it is empty, it may be useful to index the new object within the current object (i.e. the source of the “cr” request), and give it an automatically generated key (name) such as the current date and time.

An “invoke” request will package a group of arguments and pass them to “on(invoke)” rules in a specific field or fields in a target object. When received, the invoke request does not make or propose changes to the target object. It merely causes invoke rules to fire, and passes arguments to them. The path to the target object is specified using a preceding “to” clause, and the source of information is specified using a preceding “from” clause; otherwise, they each default to the present object.

An “ar” request may be used to add a rule. An “ar” request attaches a new rule to a field. Conversely, an “rr” request may be used to remove a rule. An “rr” request deletes a rule from a field. The object where such rule is added or deleted is specified by a preceding “to” clause.

An entire field may be deleted with the use of a “df” request. The object where such field is deleted is specified by a preceding “to” clause. It may be useful to have a way of deleting entire groups of fields using a form such as a “wildcard” name; for example, the request “df u.foo.*” could delete all fields in the target object whose fieldnames begin with the characters “u.foo.”, such as “u.foo.a” and u.foo.bar”.

A “save” request is an example of a request type which is referred to as a “workspace request”. Specifically “save” causes the interpreter to save the entire containing workspace to its backing file. Such a request is useful prior to running a garbage collector, for example. The workspace to be saved may be specified by a path in a preceding “to” clause directed to any object in that workspace. Preferably, workspace requests should allow a destination path to any object in the target workspace, but they should nevertheless act as if the request were directed to the root object of the workspace, where an “on(workspace)” rule may be placed to respond to all such requests to the entire workspace. Other useful workspace requests may include “rename” which requests a workspace to change its name, “shutdown” which requests a workspace to stop running, “debug” which requests a workspace enter a debugging mode, “run <workspace>” which requests the interpreter begin running another workspace called “<workspace>”, and so on. Since typically the interpreter, and thus the workspace, has no direct user-interface available to it except for the request interface, workspace requests make a convenient and easy-to-implement interface for asking the interpreter to perform miscellaneous operations.

When we refer to an action produced by a request, this should be understood to refer to the action effected by the interpreter that receives and processes the request.

Frames:

The first step 801 in a frame occurs when an interpreter 407 removes and processes a request 409 from the Input Request Queue 411. Once the pathstring, contained in the header of the request 409 is resolved, the request is sent to a target object 707. The request processor in interpreter 407 is then invoked on the target object, as shown in step 803.

Once the target object 701 has been identified, the request types found in the payload of request 412 preferably are applied to the target object via a “glass pane” mechanism 709, as shown in step 805. The glass pane mechanism 703 is used as a vehicle which allows “previewing” all of the changes proposed to a target object prior to making any alterations to the target object. In other words, all the proposed changes or actions to the target object will be made in a temporary copy, in memory, of the object, allowing the rules associated with the object to determine if the changes are to be allowed. The frame accesses only local information from the target object and the request. In a frame, there is no order in which fields are changed or rules fired. It is as if fields change and then the attached rules fire when ready. That is, rules operate independently and asynchronously relative to one another.

An important requirement for frames is that almost all the information needed to complete the frame's processing must be within a single object, the target. If supporting information is needed from elsewhere, it must be requested in advance, and the frame's processing cannot start until all necessary information has arrived. The exceptions to this requirement are listed above in the description of expressions and where they can get information used in their evaluation.

A request for additional data, from an object other than the target object, may not be made until the current frame has been completed. The frame always makes progress; nothing in the frame is allowed to wait for any reason.

Once the glass pane mechanism 703 has been implemented, the rules 705, associated with the fields data 707 which have been affected by the changes to the target object 701, are identified in act 807. The identified rules are then fired in act 809. A determination is then made, act 810, whether the proposed changes to the glass pane 703 have met the conditions associated with the rules of the affected fields.

With one exception, if a single alteration to the glass pane is rejected, the entire frame will be aborted and control will branch to line 811. In other words, either the entire frame is allowed or the entire frame is rejected. The one exception to the “all or nothing” operation is the remove rule action (rr). The remove rule requests are preformed immediately, and cannot be rolled back. This processing allows a user to remove bad rules, syntax errors for example, before they attempt to fire and cause an abort, thus preventing their own removal. User defined exceptions may also be implemented in the computing system.

If the conditions have not been met, the frame is aborted at 811, and the glass pane is erased, act 813. New requests 709, which may have been generated by the rules associated with the target object 707 or the original request 409, also are aborted and therefore not processed. Aborted frames may cause a problem report 711 to be generated and placed in the target object's error field and/or stored in an error bucket, act 815.

Each workspace contains an error bucket, which is implemented as an index object in a known location; for example, at the path “/system/problem reports” in each workspace. Once an error is detected, the frame aborts and a “cr” create request message containing the abort information is sent to the error bucket, along with the request which triggered the aborted frame and the GUID of the object in which the error occurred, i.e., the target object. At this time, a snapshot of the target object also may be captured, for use in debugging later. The major request associated with the aborted frame is placed in a system problem report, which essentially is a queue of requests associated with aborted frames. A software developer may easily find all the errors in the system in the error bucket along with the objects in which the errors occurred. Often, an error may be easily fixed by amending or adding new rules or changing data. Thus, the error bucket provides an easy method for a software developer to identify bugs in the system and where they originated. Once the errors have been corrected, a software developer may remove any associated requests from the system problem report queue, and optionally resubmit them to the input queue of the workspace so they may be re-executed.

Thus at least some embodiments of the invention virtually eliminate the need for error and exception handling code. Instead of a software developer investing a great deal of time constructing code dealing with exceptions which may occur, a software developer may now simply let them occur. Once an error is detected, all processing for the associated request is halted, and all erroneous activity is backed out as if it never happened; therefore, errors will not greatly impact an entire computing system. Furthermore, an error is capable of being easily located and corrected.

If the conditions have been met, at 817, the frame is processed and the alterations made to the glass pane are permanently transferred to the target object, act 819. All new requests 709 which may have been generated by the rules associated with the target object 707 or the original request 409, are processed, act 821. Processed requests may be sent to the Input queue, in order to send a request message to an object in the current workspace; to the shortcut queue, in order to make further requests to the current object; or to the output queue, in order to send a request message to an object located in another workspace.

Data Integrity:

The current invention provides an effective means for avoiding data locking. In a database and enterprise software, in general, data locking is a critical requirement in order to assure data reliability. Whether a single copy of data is maintained or multiple, “mirror” copies (e.g., in a distributed database or other application), it is critical that applications and users all perceive a particular datum to have the same value at the same instant and that only one user or program process be allowed to alter the datum at any instant. For example, assume the system were used to track an inventory. If a first user wished to remove an item from the inventory, a second user wished to add an item to inventory and a third user wished a report on the inventory at the same time, the third user would get an inaccurate count if it read the quantity while the first or second users were in the middle of changing the amount. Here, each operation must move to completion before the next occurs, owing to the handling of the request queues. A request would be made to the object representing the inventory. Provided there are no syntax errors in the request, the request would decrease or increase the number of items listed in the field associated with the inventory item, or simply read the contents. The request might also send the user a notification message that the request had been successfully processed. Each request would be completed in a controlled sequence. Two requests could not take control of the same datum at the same time as a frame may not be interrupted and only one frame may run on an object at a time.

Since a frame may not be interrupted, there is no possibility of another user attempting to access the inventory before a prior user's operation on the inventory could be completed. Therefore, problems like potentially selling the same items to two customers are prevented and data integrity is assured.

Data Security:

The current invention also provides a means of implementing security gateways for both workspaces and individual objects. An object may be made responsible for its own security with the use of rules. For example if a request is made to acquire data from an object, a rule may be placed in that object which allows such a request to be honored only under specific conditions, such conditions as coming from an object originating in the same workspace or from an object which presents credentials such as an access password, and otherwise denying the request. Similarly, workspaces may also provide a level or security. For example, workspace A may allow all incoming requests from various other workspaces but may exclude workspace B. As an alternative, workspace A may allow all incoming requests but object C, in workspace A, may be able to reject all requests originating from workspace B. Thus, multiple layers of security may be implemented.

A system and method have thus been shown which greatly simplify, and therefore speed up the task of developing many types of software systems, particularly enterprise software. A software development environment is provided wherein a user, via a UI, creates one or more workspaces on one or more computers. Each workspace starts with a single root object. The user/programmer develops the software system by adding objects in such workspaces, the objects being arranged in a tree branching from the root object. Each object is a data structure in memory at one of the computers. In the data structure of an object are fields for holding data and rules pertaining to the data. Interaction of objects is controlled via messages, called requests, routed through queues that are managed to assure orderly operation of the system. Once a request has been issued from an Input Request Queue, an interpreter associated with each workspace will determine a target object by resolving the pathstring associated with the issued request. Once the target object has received the request, rules associated with the affected fields determine what actions occur. A Loop-Around Request Queue may be used in order for the target object to issue requests to itself at higher priority, avoiding interruption of processing within the object. A frame mechanism prevents the target object from receiving a new request from the Input Request Queue until after the preceding request is finished. Once the frame has completed, the target object may send any necessary requests to the Request Queues and will also be able to receive a new request from the Input Request Queue. Thus, during the operation of a frame the target object is not capable of being interrupted.

Improved methods of software programming have also been presented. Incremental programming may be achieved with the addition of workspaces or objects which do not require programming updates to the preexisting computing system. Programming updates to current objects may also be easily obtained by simply adding or modifying rules within the fields of the object.

Owing to the asynchronous handling of frames and requests, listener objects can provide up-to-date, “live” data for output screens, be they local or remote. Thus a UI need not burden the system by repeatedly polling to refresh a display. If a change happens, it will be “pushed” right to the output device. Correspondingly, if a datastream changes, the change can be rapidly propagated whenever it is needed.

Improved methods of data sampling are also possible with at least one embodiment of this invention. No longer will there be a need for methods, such as polling, wherein data is constantly pinged in order to check its status and report a change therein. Embodiments, if desired, allow the data to report changes to itself by implementing a rule which will send a request to a user once the data field associated with the rule has been modified, or modified in a particular way. Thus, system resources are used more efficiently.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for use in a computing system, the method comprising:
creating in a memory of a computer a workspace which comprises a root object;
creating in the workspace, at least one additional object, different from the root object, wherein the at least one additional object comprises at least one field for containing data and at least one rule, wherein the at least one rule defines a behavior which is to occur when specified data conditions are satisfied;
providing a queue which receives a request for actions with respect to the at least one additional object in the workspace; and
providing an interpreter which evaluates the request received from the queue and fires the at least one rule when the specified data conditions are satisfied.

2. The method of claim 1, wherein providing a queue comprises:
providing a short-cut request queue which receives minor requests from the at least one object addressed to itself and provides such requests to the interpreter.

3. The method of claim 1, wherein providing a queue comprises:
providing an input request queue which receives major requests from at least one object, other than the at least one object receiving the request, or from a user and provides such requests to the interpreter.

4. The method of claim 3, wherein receiving major requests comprises:
receiving a request from an adapter and providing sad request to the input request queue.

5. The method of claim 4, wherein receiving a request from an adapter comprises:
receiving a request from an external source.

6. The method of claim 4, wherein receiving a request from an adapter comprises:
receiving a request from another workspace.

7. The method of any of claims 1-6, wherein firing the at least one rule comprises:
providing modifications to the at least one additional object in temporary memory location and if said modifications are completed without the occurrence of an error, the modifications are permanently made to the at least one additional object.

8. The method of claim 1, wherein all minor requests on a short-cut queue are processed before a next major request on an input request queue, for the same at least one additional object, is processed.

9. A method for use in a computing system, the method comprising:
creating in a memory of a computer a workspace which comprises a root object index;
creating in the workspace, at least one additional object different from the root object index; and
providing an addressing system wherein the root object index and the at least one additional object are associated in a tree structure through a key associated with the at least one additional object.

10. A method for use in a computing system, wherein the computing system comprises an object in a workspace, the object further comprising at least one field comprising data and at least one rule, the method comprising:
isolating the object once said object has received a first request for actions, with respect to the object, from an input request queue; and
processing the first request by evaluating at least one rule associated with the object and wherein the object may not receive a second request for actions until the first request has been completed.
